(19) United States
(12) Patent Application Publication
(10) Pub. No.: US 2026/0030801 A1
(43) Pub. Date: Jan. 29, 2026

(54) STAIN UNMIXING OF MULTIPLEXED BRIGHTFIELD IMAGES

(71) Applicant: VENTANA MEDICAL SYSTEMS, INC., Tucson, AZ (US)

(72) Inventors: Qinle Ba, Tucson, AZ (US); Auranuch Lorsakul, Tucson, AZ (US); Jim F. Martin, Tucson, AZ (US); Satarupa Mukherjee, Tucson, AZ (US); Nahil Sobh, Tucson, AZ (US); Xingwei Wang, Tucson, AZ (US)

(73) Assignee: VENTANA MEDICAL SYSTEMS, INC., Tucson, AZ (US)

(21) Appl. No.: 19/349,134

(22) Filed: Oct. 3, 2025

Related U.S. Application Data
(63) Continuation of application No. PCT/US2024/026630, filed on Apr. 26, 2024.
(60) Provisional application No. 63/499,098, filed on Apr. 28, 2023.

(51) Int. Cl. G06T 11/00; G06T 7/90

(52) U.S. Cl. CPC G06T 11/001; G06T 7/90; G06T 2200/24; G06T 2207/10024; G06T 2207/20081; G06T 2207/30024; G06T 2210/41

(57) ABSTRACT

The present disclosure relates to stain unmixing of digital pathology images by determining initial color vectors associated with digital pathology stains (or chromogens) from pure-color digital pathology images. The determined color vectors may be fine-tuned or adjusted to help improve the stain unmixing performance. The adjustment may be performed via the interface and/or automated technique that, based on a real multiplex image and one or more synthetic singleplex images, perform adjustments to the color vectors. These adjusted color vectors may be further leveraged for stain unmixing of a given multiplex image. Additionally, the disclosure provides techniques to generate synthetic pixels and the associated color vectors, a recommended stain to be added to a multiplex image and/or generation of multiplex images from one or more digital pathology images based on the targeted color vectors.

### CROSS-REFERENCE TO RELATED APPLICATIONS

This application is a continuation of International Patent Application No. PCT/US2024/026630, filed Apr. 26, 2024, which claims the benefit of and the priority to U.S. Provisional Application No. 63/499,098, filed on Apr. 28, 2023. The entire disclosures of the aforementioned applications are incorporated by reference herein in their entireties for all purposes.

### BACKGROUND

Digital pathology facilitates correctly diagnosing subjects and guiding therapeutic decision making. In digital pathology solutions, image-analysis workflows are used to automatically detect or classify biological components of interest (e.g., cells that have one or more particular proteins or antigens). An exemplary digital pathology solution workflow includes obtaining tissue slides, scanning preselected areas or the entirety of the tissue slides with a digital image scanner (e.g., a whole slide image (WSI) scanner) to obtain digital images, and performing image analysis on the digital images. The digital images are processed using one or more image analysis algorithms, which can facilitate detecting cells labeled with one or more signals of interest and quantifying such signal using image analysis (e.g., quantitative or semi-quantitative scoring such as positive, negative, medium, weak, etc.).

Digital pathology may use singleplex or multiplex techniques. Singleplex uses a single stain for just one biomarker along with a reference stain. Meanwhile, multiplex involves the staining for two or more biomarkers (in addition to the reference stain) in a single slide or tissue sample. Therefore, multiplex techniques support simultaneous detection of multiple biomarkers and their co-expression at a single-cell level. To process multiplex images, an unmixing process may be performed to separate signals from different markers. More specifically, a color unmixing method may be performed to decompose an RGB image into its individual-constituent stain/dyes for each biomarker. This facilitates estimating—for an individual cell—a staining level for each of multiple stains.

One exemplary unmixing technique is color deconvolution, which can be used to unmix signals in an RGB image with up to three stains in the converted optical density space. (See Ruifrok A C, Johnston D A Quantification of histochemical staining by color deconvolution. Anal Quant Cytol Histol. 2001 August;23(4):291-9. PMID: 11531144, which is hereby incorporated by reference in its entirety for all purposes.) Another exemplary unmixing technique formulates the color unmixing problem into non-negative matrix factorization (NMF) and performs color decomposition in a fully automated manner, wherein no reference stain color selection is required. (See Lee, Daniel, and H. Sebastian Seung. “Algorithms for non-negative matrix factorization.” Advances in neural information processing systems 13 (2000), which is hereby incorporated by reference in its entirety for all purposes.) However, each of these techniques may produce sub-optimal results that include blurriness, missed signals, and noise. Unmixing approaches become particularly challenging as a number of stains that are used increases. For example, in a triplex situation (where there are three biomarker stains and one reference stains), an unmixing approach attempts to convert a three-channel RGB image into a four-channel output. This can result in inaccurate predictions.

These sub-optimal results may be due to (for example) multiple stains colocalizing in same types of cell parts (e.g., with multiple stains potentially colocalizing in cell nuclei or with multiple stains potentially colocalizing in cell membranes). For example, in multiplex imaging, a biomarker that is frequently used is hematoxylin, which is used for staining the nuclei of cells, so that the pathologists can visualize the tissue structure, and determine which cells are negative for all biomarkers. The cell, as it is stained in our images, is usually apportioned into three primary areas: the nucleus, the cytoplasm, and the membrane. Biomarkers may be designed for any of these areas. In duplex imaging, up to three stain colors may appear in a cell, and depending on the specific biomarkers, and more than one may fall in one of these areas. This is called colocalization. However, the colocalization can result in the pixels appearing as another color associated with a separate stain and/or can make it difficult to estimate expression levels.

The sub-optimal results may also or alternatively be due to stain smearing across areas of the cell that are not specific to the biomarker. For example, if a purple stain is attached to cytoplasm or membrane, it often adds a purple color to nuclei even though the stain is not specific for that part of the cell. Still further, current unmixing techniques typically rely on experimental results to identify a color vector for each. However, a true color vector may depend on a type of tissue, a lighting, a particular imaging device, etc. Therefore, it would be advantageous to identify a new unmixing approach that more reliably delivers higher-quality results.

### SUMMARY

Some embodiments of the present disclosure relate to stain unmixing of digital pathology images by determining initial color vectors associated with digital pathology stains and adjusting the color vectors through a graphical user interface (GUI). The computer-implemented method includes determining color vectors associated with (e.g., at least three) digital pathology stains (e.g., chromogens or fluorophores) from given digital pathology images that are collected using brightfield imaging. To facilitate determining the color vectors, each pixel of a digital pathology image can be mapped from an RGB space to a position in an optical density (OD) space. Though each fluorophore used to stain the sample may be associated with a predefined color vector, performing an unmixing process using those color vectors may result in sub-optimal results. This can be due to imaging systems, lighting, etc. differing across facilities. For example, even if a “green” dye is used that is configured to only have green color (and no red or blue component), environmental lighting or an imaging system associated with a particular facility may result in an image having some amount of red and/or blue intensities in a stained region.

Therefore, fine-tuning or adjusting the color vectors may help improve the stain unmixing performance. The adjustment may be performed via the interface and/or an automated technique that includes: a visual/pictorial representation in color space of the determined color vectors (e.g., in hue saturation density (HSD) space), a real multiplex digital pathology image hereinafter as multiplex image that depicts a biopsy section stained with the at least three digital pathology stains associated with the determined color vectors. The interface may also include synthetic singleplex images associated with each stain of the multiplex image. A synthetic singleplex image may be generated by filtering the multiplex image using a determined color vector. To illustrate, a tool may allow a user to adjust a color vector for a “green” dye to a vector that includes some element of red and/or blue, which may better capture the light component for the “green” signal in a given image and may facilitate unmixing for the given image.

Additionally, the interface may provide one or more color adjustment tools enabling a user to adjust or fine-tune each determined color vector interactively. The input received through user interaction with the interface may be detected, specifically targeting adjustments made to the determined color vector associated with a particular stain. In response to detecting the input, the interface may be automatically updated (e.g., to represent a changed orientation/proximity of the determined color vectors in the representation space and/or to show an exemplary unmixing result produced using the adjusted color vector). This process may support precise and responsive customization of stains in accordance with the multiplex image provided via the interface thereby improving stain unmixing performance.

In some instances, one or more color vectors may be determined using one or more single-stain (or pure-color) images. These images may depict a same or a different biopsy section compared to the multiplex image. The single-stain images may be stained with only one of the digital pathology stains used for staining the multiplex image, though it may be captured in a same environment and using a same imaging system as for the multiplex image. The representation of each of the determined color vectors may also include a marker overlaid at a particular position within the digital pathology image. The particular position of the marker may be used define the a color vector for a corresponding stain (or an initial color vector, which may thereafter be adjusted based on user input or further processing). In one aspect, the color vectors may be determined using non-negative matrix factorization (NMF).

The visualization of synthetic singleplex images via the interface may help validate the correctness of the adjusted color vectors. The synthetic singleplex images may be regenerated with the update in the interface that corresponds to the adjustments in the determined color vectors. These synthetic singleplex images may be further combined to generate a synthetic multiplex image that may be compared to the real multiplex image during training and/or as an indicator of a confidence of adjusted color vectors. For example, a graphical user interface may present both the synthetic and real multiplex images, and user input that adjusts one or more color vectors can trigger dynamic updates to the synthetic multiplex image.

In some embodiments, filtering may be performed by leveraging one or more machine-learning models (such as generative models) that may be trained to learn the mapping from a given multiplex image to its constituting singleplex images conditioned on a one or more color vectors (defined using one or more techniques disclosed herein).

Once color vectors are defined (e.g., using one or more techniques disclosed herein), the color vectors can be used to unmix a new multiplex image to generate a set of synthetic singleplex images (each corresponding to a given biomarker stain or reference stain). The new multiplex image may be stained using the same stains as the multiplex image used in the interface and/or automated technique for color adjustments. In some instances, the fine-tuned color vectors may be determined based on (for example) a different multiplex image than that of the new multiplex image used for further stain unmixing. The fine-tuned color vectors can then be used to generate one or more synthetic singleplex images from the new multiplex image. In some instances, these synthetic singleplex image(s) are generated from the same multiplex image that is used in the interface and/or automated technique to support the fine-tuning of the color vectors.

In some embodiments, the present disclosure provides a method to determine the adjustment of an initial color vector associated with a specific stain based on a given real multiplex image that may not include the specific stain. The computer-implemented method includes determining the initial color vectors associated with e.g., at least three stains from the corresponding pure-stain digital pathology images. The method may further include accessing a real multiplex image that is stained using one or more stains associated with the initial color vectors but not including at least one of these stains. For reference purpose, at least one stain that is not present in real multiplex image is referred to as “specific stain”. The initial color vectors may be fed to a filter that is configured to generate a filtered output from the real multiplex image based on the specific stain. Filtering may be performed by employing one or more machine-learning models such as generative models trained to learn the mapping from a given multiplex image to its constituting singleplex images. The generative model such as a GAN may be conditioned on a color vector such that if the model encounters a color vector that is absent in the input multiplex image, it may not be able to generate any meaningful output related to that stain, resulting in a zero or a null image. On the contrary, if such a model is given a color vector present in the given multiplex image, it may generate the constituent singleplex image associated with that color vector.

To assess the quality of the filtered output, a metric can be calculated that characterizes a degree of variation in staining intensity across all or part of the filtered output. For example, when it is predicted (or known) that there are no biomarkers corresponding to a given stain (or color vector) in the real multiplex image, it could be expected that the metric (e.g., mean, median, mode, variance, standard deviation and/or range) may be relatively low when conditioned on accurate color vectors as compared to when less accurate color vectors are used. Once the metric is determined quantifying the filtered output based on the extent to which a stain is present in the real multiplex image, a space-traversal technique (e.g., gradient descent, Monte Carlo method) may be leveraged to find a color vector adjustment associated with the specific stain. These adjustments can be incorporated to the color vector of the specific stain via the interface.

Once the color vector associated with the specific stain is adjusted by minimizing the metric, a new multiplex image may be received. This multiplex image may be stained with at least one of the stains associated with the initial color vectors. It may also include the specific stain(s) for which the color adjustments are computed based on the metric and the space-travel technique. By leveraging the stain unmixing process of an unmixing technique such as NMF, a new synthetic singleplex image may be generated that is associated with the specific stain. Finally, the generated unmixed output may be displayed via the interface.

In another example, techniques may be provided to find a recommended color vector for a given multiplex image. For example, a duplex image stained with two specific stains along with a counterstain (e.g., hematoxylin). The objective may be to identify a potential additional stain that is distinguishable among the existing stains, thereby transforming the duplex into a triplex image. The computer-implemented method may include determining initial color vectors associated with e.g., at least two stains from the corresponding pure-stain digital pathology images. The method may further include accessing a real multiplex image that is stained with at least two stains associated with initial color vectors. The additional stain may be selected such that it is not related with any of the stains of the multiplex image in a multi-dimensional color space.

An initial stain may be selected or engineered and the associated initial color vector may be determined by using, e.g., an NMF technique. Using this initial color vector, the real multiplex image may be filtered by leveraging a machine-learning model that is configured to map a given multiplex to one of its constituting synthetic singleplex image based on the provided color vector. For characterizing the filtered output, a metric (e.g., a mean mode or median) can be computed, where the metric quantifies the amount of stain present in a given multiplex image. For example, if the selected color stain is not distinguishable, the computed metric such as mean of a synthetic OD singleplex image may have a higher value thus, indicating the presence or a similarity to the already existing stains. The metric may be estimated by leveraging a space-traversal technique that may include one or more objectives in the traversal. The corresponding adjustments to the initial color vector can be found based on the space-traversal technique that minimizes the metric for the filtered output. Finally, the recommended color vector that is not related to the stains already present in the multiplex image may be output through the interface.

Other aspects of the present disclosure include a method of determining a performance-prediction score that represented a predicted extent to which at least three digital pathology stains are sufficiently separable in practice to reliably support generation of synthetic singleplex images. The method may include determining initial color vectors associated with e.g., at least three stains from the corresponding pure-stained digital pathology images. A real multiplex image may be accessed that is stained using one or more stains associated with the initial color vectors but not including at least one of these stains (termed as “specific stains”). The initial color vectors may be fed to a filter that is configured to generate a filtered output from the real multiplex image based on the specific stain. One or more machine-learning models, such as a generative model, may be trained to learn a mapping from a given multiplex image to its constituting singleplex images for filtering purpose. If such a model is conditioned on a color vector absent in the input multiplex image, it may not be able to generate any meaningful output related to that stain, resulting in a zero or a null image. The performance-prediction score can be generated for the filtered outputs and/or for other synthetic singleplex images that constitutes the real multiplex image. The performance-prediction score may be output, and adjustments may be performed to the initial color vectors based on this performance-prediction score via the GUI.

In some instances, the performance prediction score may include a mean, median, or mode intensity of a corresponding filtered output. For example, when it is predicted (or known) that there are biomarkers corresponding to a given stain in a given depicted sample or multiplex image, it could be expected that the performance-prediction score e.g., a mean, median, mode, variance, standard deviation and/or range may be relatively high when accurate color vectors are used as compared to when less accurate color vectors are used.

In another instance, the performance-prediction score may be estimated by grouping or clustering similar stains together based on staining features of the one or more singleplex images. For example, staining features may include optical density values, color histograms, or any other feature that may capture staining patterns effectively. In other examples, the performance-prediction score may be calculated for synthetic singleplex images by estimating correlation between each staining pattern observed in the multiplex image.

In some aspects, stain unmixing is performed by a constraint method that can reduce the complexities of a multiplex image (e.g., stained with four stains) thus, support more precise, and/or more reliable generation of synthetic singleplex images from a multiplex image. The computer-implemented method includes determining initial color vectors associated with e.g., at least four stains from the corresponding pure-stained digital pathology images. In some instances, each pixel in a digital pathology image may be mapped to a position within a multi-dimensional color space. Among these four stains, a specific stain may be selected such that it is attributable to a prominent portion (e.g., a quadrant, a portion defined by greater than/less than some y-value and greater/less than some x-value, a wedge, cylinder etc.) of the color space. The method further includes accessing a real multiplex image that is stained with at least three digital pathology stains. Each pixel of the real multiplex image may also be mapped to a point in the multi-dimensional space. For each pixel, a pixel-specific vector may be generated that predicts a degree of expression for each of at least four stains in the part of the biopsy section that is depicted at the pixel.

The process of generating the pixel-specific vectors may further include assigning pixels within the specific portion of the color map to a specific color vector that predicts an expression level for a biomarker corresponding to that portion. For each pixel of associated with the specific portion, optical density may be determined. The pixels outside that portion may be assigned a “0” (or other predefined expression level) for each other biomarker corresponding to the multiplex image. For pixels outside of the first portion, an unmixing technique can be used to predict expression levels for each of the other biomarkers, and a predicted expression level of “0” (or other predefined number) can be associated with the first biomarker. Finally, one or more synthetic singleplex images may be generated using the pixel-specific color vectors.

The particular stain may be selected based on information about what parts of cells each of the at least four digital pathology stains are configured to stain. The color space can include an International Commission on Illumination (CIE) color space. The portion of the color space can include a wedge. The portion of the color space can include a portion of the space defined based on an inequality with respect to an x-coordinate and an inequality with respect to a y-coordinate. The portion of the color space can include a combination of primitives. Performing the unmixing technique can include using nonnegative matrix factorization (NMF). The color vectors can be determined based on one or more user inputs received using one or more color-vector adjustment tools available within an interface.

In some instances, a computer-implemented method is provided that includes: determining, for each stain of at least three digital pathology stains, a color vector that represents the stain; availing an interface to a user device, wherein the interface includes: a representation of each of the determined color vectors; a real multiplex digital pathology image that depicts a biopsy section stained with two or more of the at least three digital pathology stains; at least one synthetic singleplex image, wherein each of the at least one synthetic singleplex image is generated by filtering the real multiplex digital pathology image using a single one of the determined color vectors; and one or more color-vector adjustment tools, wherein each of the one or more color-vector adjustment tools are configured to receive user input corresponding to an adjustment of a color vector representing a corresponding stain of the at least three digital pathology stains; detecting an input received via an interaction with the interface that corresponds to a particular adjustment of the color vector representing a particular stain of the at least three digital pathology stains; and in response to detecting the input, automatically updating the interface.

The representation of each of the determined color vectors may include a

representation of a position within an optical density space. The updated interface may further include the at least one synthetic singleplex image. The one or more color-vector adjustment tools may include at least three color-adjustment tools. Determining the color vector may include processing one or more single-stain images that depict a same or other biopsy section that had been stained with only one of the at least three digital pathology stains. The one or more single-stain images may include a marker overlaid at a particular position within a multi-dimensional color space and, wherein the color vector is defined based on the particular position. The real multiplex digital pathology image may depict the biopsy section stained with at least four stains. The determined color vectors may be within a two-dimensional color space, and wherein the method further comprises: determining a portion of the color space that is predicted to be attributable to prominent signals that correspond to a specific stain of the at least three digital pathology stains; wherein the automatic updating of the interface is performed using an unmixing technique that selectively focuses on the at least three digital pathology stains, less the specific stain. The determination of the color vector may be performed using non-negative matrix factorization. The method may further include: receiving a new multiplex image stained with at least one of the at least three digital pathology stains; generating a new synthetic singleplex image based on the new multiplex image and the adjusted color vector; and outputting the new synthetic singleplex image. The real multiplex digital pathology image may be filtered by using the color vector and a machine-learning model.

In some embodiments, a computer-implemented method is provided that includes: determining, for each stain of at least three digital pathology stains, a color vector that represents the stain; accessing a real multiplex digital pathology image that depicts a biopsy section stained with at least one first stain of the at least three stains, wherein the depicted biopsy section is not stained with at least one second stain of the at least three stains; generating a filtered output by filtering the real multiplex digital pathology image using the color vector that represents a second stain of the at least one second stain; generating a metric that characterizes a signal characteristic in the filtered output; using the metric and a space-traversal technique to identify an adjustment of the color vector that represents the second stain; receiving a new multiplex image stained with at least one of the at least three digital pathology stains; generating a new synthetic singleplex image based on the new multiplex image and the adjusted color vector that represents the second stain; and outputting the new synthetic singleplex image.

For each stain of the at least three digital pathology stains, the color vector may be a vector in an optical density space. The space-traversal technique may include a gradient descent technique. The space-traversal technique may include a Monte Carlo technique. The metric may include a mean, median or mode intensity. The metric may characterize a level of staining across all or part of the filtered output. The filtered output may be generated by using a machine-learning model.

In some embodiments, a computer-implemented method is provided that includes: determining, for each stain of at least two digital pathology stains, a color vector that represents the stain; accessing a real multiplex digital pathology image that depicts a biopsy section stained with the at least two digital pathology stains; identifying a recommended color vector that represents a potential additional stain by: identifying an initial color vector; generating a filtered output by filtering the real multiplex digital pathology image using the initial color vector; generating a metric that characterizes a signal characteristic in the filtered output; and using the metric and a space-traversal technique to identify the recommended color vector; and outputting the recommended color vector.

The space-traversal technique may be performed to include, as one or more objectives in a traversal, to minimize a signal in the filtered output. Minimizing the signal in the filtered output may include minimizing a mean, median, or mode intensity of a corresponding filtered output. The determination of color vectors may be performed using non-negative matrix factorization. For each stain of the at least two digital pathology stains, the color vector may be a vector in an optical density space. The filtered output may be generated by using a machine-learning model. The space-traversal technique may include a gradient descent technique.

In some embodiments, computer-implemented method is provided that comprises: determining, for each stain of at least three digital pathology stains, a color vector that represents the stain; accessing a real multiplex digital pathology image that depicts a biopsy section stained with at least one first stain of the at least three digital pathology stains, wherein the depicted biopsy section is not stained with at least one second stain of the at least three stains; generating a filtered output by filtering the real multiplex digital pathology using the color vector that represents a second stain of at least one second digital pathology stains; generating a performance-prediction score that represented a predicted extent to which the at least three digital pathology stains are sufficiently separable in practice to reliably support generation of synthetic singleplex images; and outputting the performance-prediction score.

The performance-prediction score may be generated using the filtered output. The performance-prediction score may include a mean, median, or mode intensity of a corresponding filtered output. The performance prediction score may include a correlation coefficient between each pair of synthetic singleplex images associated with the filtered output. For each stain of at least three digital pathology stains, the color vector may be a vector in an optical density space. The filtered output may be generated by using a machine-learning model. The color vector may be adjusted via a graphical user interface (GUI) based on the performance-prediction score.

In some embodiments, a computer-implemented method is provided that includes: determining, for each stain of at least four digital pathology stains, a color vector that represents the stain, wherein the determined color vectors are within a multi-dimensional color space; selecting a specific stain of the at least four digital pathology stains; determining a portion of the color space that is predicted to be attributable to prominent signals that correspond to the specific stain; accessing a real multiplex digital pathology image that depicts a biopsy section stained with at least three digital pathology stains of the at least four digital pathology stains, wherein the real multiplex digital pathology image includes a set of pixels; mapping each pixel of the set of pixels in the real multiplex digital pathology image to a point within the multi-dimensional color space; generating, for each pixel of the set of pixels, a pixel-specific color vector that predicts, for each of the at least four digital pathology stains, a degree of expression of the stain in a part of the biopsy section that is depicted at the pixel, wherein generating the pixel-specific color vectors includes: determining that each of a first subset of the set of pixels is mapped to a point that is within the portion of the color space; determining, for each pixel of the first subset of pixels, an optical density, wherein the pixel-specific color vector for the pixel identifies a degree of expression for the specific stain that corresponds to the optical density; determining that each of a second subset of the set of pixels is mapped to a point that is outside of the portion of the color space; and performing an unmixing technique to predict, for each pixel in the second subset and for each of some of the at least four digital pathology stains, a degree of expression of the stain in the part of the biopsy section that is depicted at the pixel, wherein the some of the at least four digital pathology stains does not include the specific stain, and wherein the unmixing technique uses the color vector determined to represent each of the some of the at least four digital pathology stains; and generating one or more synthetic singleplex images using the pixel-specific color vectors.

The specific stain may be selected based on information about what parts of cells each of the at least four digital pathology stains are configured to stain. The color space may include an International Commission on Illumination (CIE) color space. The portion of the color space may include a wedge. The portion of the color space may include a portion of a space defined based on an inequality with respect to an x-coordinate and an inequality with respect to a y-coordinate. The portion of the color space may include a combination of primitives. Performing the unmixing technique may include using nonnegative matrix factorization (NMF). The color vectors may be or may have been determined based on one or more user inputs received using one or more color-vector adjustment tools available within an interface. In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more data processors and a non-transitory computer-readable storage medium containing instructions which, when executed on the one or more data processors, cause the one or more data processors to perform part or all of one or more methods disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The present disclosure is described in conjunction with the appended figures:

FIG. 1 illustrates a workflow of obtaining and processing multiplex images, in accordance with some embodiments of the present disclosure.

FIG. 2 illustrates an exemplary network for generating digital pathology images.

FIG. 3A shows an illustrative example of a workflow to facilitate defining a color vector associated with a stain and perform stain unmixing in accordance with an embodiment of the present disclosure.

FIG. 3B illustrates an exemplary linear unmixing technique in accordance with some embodiments of the present disclosure.

FIG. 3C shows an interface component that facilitates fine-tuning of color vectors.

FIG. 3D illustrates an example architecture for generating one or more synthetic images by leveraging a plurality of machine-learning models.

FIG. 3E illustrates an example architecture for generating one or more synthetic images by leveraging a single machine-learning model.

FIG. 4 illustrates a flowchart of an exemplary process that facilitates defining one or more color vectors for stain unmixing in accordance with some embodiments of the present disclosure.

FIG. 5 illustrates a system that determines adjustment of initial color vectors based on a given multiplex digital pathology image in accordance with some embodiments of the present disclosure.

FIG. 6 illustrates a flowchart of an exemplary process for generating synthetic singleplex images using fine-tuned color vectors.

FIG. 7 illustrates a flowchart of an exemplary process to identify a recommended color vector.

FIG. 8 illustrates a flowchart of an exemplary process for generating a performance-prediction score representing a predicted extent to which constituting digital pathology stains are sufficiently separable to reliably support generation of one or more synthetic singleplex images.

FIG. 9A illustrates examples of ER-PR-HER2 triplex images where each pixel of a triplex image is mapped to a position within a multi-dimensional color map.

FIG. 9B is an illustration of stain unmixing of an example triplex ER-PR-HER2 image from the FIG. 9A in accordance with some embodiments of the present disclosure.

FIG. 9C illustrates examples of stain unmixing results of an ER-PR-HER2 triplex and one or more singleplex images using the disclosed constraint technique.

FIG. 9D illustrates examples of stain remixing results of the ER-PR-HER2 triplex and one or more singleplex images using the disclosed constraint technique.

FIG. 9E illustrates stain remixing results for a triplex ER-PR-HER2 in accordance with some embodiments of the present disclosure.

FIG. 10A illustrates a flowchart of an exemplary flowchart for performing stain unmixing for a multiplex image by using a disclosed constraint technique in accordance with some embodiments of the present disclosure.

FIG. 10B further illustrates an example flowchart of a component from the FIG. 10A.

FIG. 11A depicts a comparison of stain unmixing of a duplex image using initial color matrix and the adjusted color matrix in accordance with an example implementation.

FIG. 11B depicts a comparison of stain unmixing of another duplex and a singleplex image using initial color matrix and the adjusted color matrix in accordance with an example implementation.

FIG. 12A illustrates an example of a duplex image overlaid with markers (candidate seeds) at each nucleus that are detected by automatic nucleus segmentation.

FIG. 12B depicts a comparison of nucleus segmentation results of a hematoxylin image that is obtained by unmixing the duplex image using linear deconvolution and NMF techniques.

FIG. 13 illustrates an example graphical user interface (GUI) for generation of synthetic pixel in accordance with an example implementation.

FIG. 14A illustrates an example GUI that uses synthetic pixels for assessing range of colors from blending of multiple stains.

FIG. 14B illustrates a comparison of one or more blended colors synthetized from a stain from different reagent sources in accordance with an example implementation.

FIG. 14C illustrates an example of blending two or more stains generating a range of colors in accordance with an example implementation.

FIG. 14D illustrates assessing a range of colors assigned to hematoxylin with wedge constraint.

### DETAILED DESCRIPTION

Some embodiments of the present disclosure relate to unmixing of a digital pathology image labeled with more than three markers (e.g., three or more biomarkers and a reference stain), where the digital pathology image has three or fewer channels (e.g., red, green, and blue channels). A color vector can be defined for each of the markers, and the color vectors can then be used to perform an unmixing technique to separate signals (corresponding to the more than three markers) in the digital pathology image. These color vectors can be defined using an optical density space (e.g., instead of, or in addition to, using an RGB space). Then each pixel in an input multiplex image can be mapped from an RGB space to a position in the optical density space, where initial unmixing may be performed.

In some instances, the color vectors may be determined by inputting pure-color images (e.g., depicting slices or samples dyed with a single marker) to a linear technique, such as non-negative matrix factorization (NMF). However, the color vectors acquired from NMF may cause errors if used for unmixing. For example, background noise, faded tissue, or unclear morphology may result in a scenario where the initial color vectors do not account for signals represented in the image(s) captured in real-world environments.

In some embodiments, fine-tuning of one or more color vectors may be performed using an interactive graphic user interface (GUI) and/or automated technique. Such fine-tuning may be performed using images obtained in a particular environment (e.g., lighting), such that the color vector(s) may be defined to account for real-world, environment-specific imaging influences. For example, one or more color vectors may be defined and/or adjusted to account for any influences that an imaging system and/or lighting environment may have on a signal of a given marker or depiction thereon in a digital pathology image.

The GUI may present a real multiplex image that depicts a slice stained with multiple staining agents. The GUI may include one or more input components configured to adjust (i.e., fine-tune) a definition of one or more color vectors. For example, one or more input components can be configured to move or adjust a representation of a color vector in an optical density space or RGB space. As another example, one or more input components can be configured to adjust one or more channel representations in a color space (e.g., a contribution of one or more of a red, blue, or green channel).

The GUI may also include one or more synthetic singleplex images and/or a synthetic multiplex image, where each synthetic is (e.g., dynamically) generated based on color vectors defined in the interface. The GUI may include one or more input components that are configured to receive input that adjusts a contribution of one or more channels corresponding to a given signal.

For example, with respect to a given marker, the GUI may be configured to receive a definition or adjustment of one or more color or frequency-band channels. As another example, with respect to a given marker, the GUI may be configured to receive a definition or adjustment of a hue angle and/or optical density (representing an intensity) in an optical density space. The optical-density space can be configured to be a two-dimensional space (e.g., chromaticity cx-cy plane), where each position is a non-ambiguous identification of an RGB vector (e.g., such that position in an optical-density can be deconvolved to identify a position within the optical-density space). Within this space, an arbitrary scaling factor corresponding to an angle can be defined such that the color space spans a predefined space. Within the optical-density space, saturation may be represented by a distance from the center, and/or hue may be captured by an angle in polar coordinates.

The GUI may be configured to dynamically adjust (e.g., in real-time) one or more displayed singleplex images and/or a synthetic composite multiplex image based on a set of color vectors defined (via the interface) for the underlying channels. As an example, if the color vectors are set to be identical when an underlying image was stained with different markers, the GUI may show that all synthetic singleplex images would be identical and that a synthetic multiplex image lacks signals from a corresponding real multiplex image. Thus, a user may use this information to fine-tune the color vectors.

Once the fine-tuning is completed, the color vectors may be used to generate one or more synthetic singleplex images based on an input multiplex image. The input multiplex image to be unmixed may either be different or same from the multiplex image used to determine color vectors. Leveraging similar multiplex image may lessen the extent to which variation in colors across imaging instances (e.g., due to differences in tissue types, lighting, staining protocols, imaging systems, etc.) affect the degree to which labels can be accurately detected in a given instance.

In some instances, unmixing can be performed linearly using a NMF technique that leverages the fine-tuned color vectors and the coefficient matrix of the input (same or different) multiplex image thereby generating synthetic singleplex images. As another example, stain unmixing can be performed non-linearly by leveraging (for example) a machine-learning model, such as an autoencoder or generative adversarial network (GAN).

In an aspect of the present disclosure, a GUI may be configured to generate a color vector of a synthetic stain by blending two or more stain colors synthetically and interactively with different ratios. The color of the synthetic stain may be displayed in a chromaticity plane cx-cy via the GUI. The synthetic stain may be generated by selecting multiple chromogens (or fluorophores) to blend via user interaction from multiple preidentified chromogens (or fluorophores). Then, user input can identify relative contributions for each of the selected chromogens or fluorophores. The stain colors may be blended by generating a weighted average of the corresponding color vectors of the selected stains in an OD space, where the weights are defined based on the relative contributions. The weighted average in the OD space may then be converted back to RGB space (e.g., for a displaying purpose).

In some examples, synthetic pixels or associated adjusted color vectors obtained using the technique disclosed above may be used to generate synthetic singleplex and/or synthetic multiplex images. For example, a machine-learning model may be trained to transform an input counterstain image (such as hematoxylin) or an input multiplex image into a synthetic image based on a given adjusted color vector. The synthetic image may be used to validate the extent to which the color vectors defined (e.g., based on user input) provide a basis for accurate unmixing and/or accurate mixing. The architecture that generates synthetic images may also help in creating additional training data for machine-learning models in a faster and cost-effective manner than performing actual staining experiments in the lab. It may also enable the pathologist to have control over different staining conditions, intensities, and suitable combinations of biomarkers e.g., for the synthetic multiplex images. These synthetic multiplex images may be tailored to specific needs and applications.

In some embodiments, techniques may be provided for determining adjustments of initial color vectors based on a given real digital pathology image. The real image may be stained using one or more—but not all—stains associated with initial color vectors (where the stain(s) that are not used are referred to as “excluded stains” in the ongoing discussion). One or more generative models (e.g., including one or more autoencoders (AE), one or more image-image translation networks, one or more generative adversarial networks (GANs), etc.) can be used to generate one or more synthetic singleplex images using corresponding one or more color vectors (e.g., where at least one of the one or more color vectors is defined based on a user input received via an interface described herein). Given that it is known that there are one or more excluded stains, a target output corresponding to those stain channels would lack any signal. Thus, if a synthetic singleplex image that is generated corresponding to an excluded stain includes signal (e.g., or signal that is subjectively or objectively above a threshold), it may be inferred that one or more color vectors used to generate the synthetic singleplex image are sub-optimal.

In some instances, the synthetic singleplex image may be availed (e.g., displayed) to a user device from which input was received that was used to define one or more color vectors. Such availing may be provided in real-time or near real-time as a user adjusts one or more color vectors. In some instances, a metric (e.g., cumulative absolute intensity, variation across intensities, maximum intensity) can be computed and used to automatically adjust one or more color vectors (e.g., using a loss function that uses the metric and that is associated with one or more machine learning models to generate synthetic singleplex images). For example, when it is predicted (or known) that there are no biomarkers corresponding to a given stain (or color vector) in the real multiplex image, it could be expected that the mean, median, mode, variance, standard deviation and/or range may be relatively low (or zero) when accurate color vectors are used as compared to when less accurate color vectors are used. Once the metric is determined quantifying a synthetic singleplex output based on the extent to which a stain is present in the real multiplex image, a space-traversal technique may be leveraged to find the color vector adjustments associated with the excluded stains. The space-travel technique may systematically explore the space of possible adjustments to the color vector representing the excluded stains. Examples of such techniques may include, but are not limited to: gradient descent, Monte Carlo method, genetic algorithms, or other probabilistic optimization techniques that iteratively adjust the color vector to optimize certain criterion such as minimizing the metric calculated. This adjustment is repeated iteratively until convergence, or a stopping criterion is met. The goal is to find the optimal color vector that minimizes the metric, leading to a synthetic singleplex image that accurately represents the excluded biomarker.

Once the color vectors associated with the excluded stains are adjusted by minimizing the metric, a new multiplex image may be received. The multiplex image may be stained with the stains associated with initial colors vectors (including the one or more excluded stains for which the color adjustments are computed based on the space-travel technique and metric). By leveraging the stain unmixing process stated before, one or more new synthetic singleplex images may be generated that are associated with the excluded stains.

In yet another example, the disclosed technique may also be used to identify a recommended color vector for a stain that may supplement other stains depicted in a given multiplex image. This multiplex image may be stained with at least two stains. For example, a duplex image stained with two specific stains along with a counterstain (e.g., hematoxylin). An objective may be to identify a potential additional stain that is effectively distinguishable among the existing stains. Thus, a high score may be assigned via the objective function if an unmixing result can accurately distinguish between different stain signals (e.g., signals from one or more existing stains and one or more potential additional stains).

An interface may be configured to receive user input that identifies a color vector of the additional stain and that presents one or more predicted unmixing outputs (e.g., one or more synthetic singleplex images) if the additional stain is used with one or more existing stains. Additionally or alternatively, a color vector of the additional stain may initially be automatically selected (e.g., using a predefined selection of the color vector, a default user selection of the color vector, or an initial result from a linear or nonlinear processing). For example, an interface may be configured to receive user input that identifies a particular chromogen or fluorophore, and a color vector associated with the particular chromogen or fluorophore can be initially assigned to the additional stain.

Using one or more color vectors defined in accordance with a technique disclosed herein, a real multiplex image may be transformed into one or more synthetic singleplex images (e.g., using an unmixing technique disclosed herein, such as a linear unmixing technique, a non-linear unmixing technique, or a machine-learning model). To characterize a quality of the one or more synthetic singleplex images, one or more metrics can be computed. To illustrate, in a circumstance where an input image depicts a sample slice that was not stained with a given stain (e.g., but that was stained with one or more other stains), a metric may quantify an extent to which a signal associated with the given stain is present in a synthetic singleplex image. For example, the metric may be an average, median, maximum, or range of the intensities in the synthetic singleplex image. In this scenario, an ideal synthetic singleplex image would include no signal (since it is known that the given stain was not present in the initial slice), so an ideal metric would be zero. The metric and/or the synthetic singleplex image may be presented on an interface, such that they can inform a user's fine-tuning of one or more color vectors.

In another scenario, a metric can be computed that characterizes a synthetic singleplex image that corresponds to a stain that was actually used to stain the corresponding multiplex slice. In this scenario, signal components would be expected in the synthetic singleplex image, so a metric that is not close to zero may be expected (if it is known that the slice has the biomarker corresponding to the stain).

A performance-prediction score can be generated using one or more metrics and potentially using one or more target metrics. For example, the performance-prediction score (or a contributing component thereof) may be defined to be positively correlated with a metric for a synthetic singleplex image characterizing signal presence (e.g., a mean, median, mode, maximum) or signal complexity (e.g., variation or range) when it is known that a sample depicted in a corresponding multiplex image does have signal from a stain associated with the synthetic singleplex image. Further, the performance-prediction score (or a contributing component thereof) may be defined to be negatively correlated with a metric for a synthetic singleplex image characterizing signal presence or signal complexity when it is known that a sample depicted in a corresponding multiplex image does not have signal from a stain associated with the synthetic singleplex image (e.g., because the stain was not applied to the sample). Thus, the performance-prediction score may be generated in a manner such that the score represents the degree to which stains can be accurately detected and/or distinguished in a multiplex image.

In some instances, the performance-prediction score may further or alternatively be estimated by performing a clustering analysis based on image features associated with multiple synthetic singleplex images. For each synthetic singleplex image, one or more features may be defined or learned to characterize (for example) optical-density values in an image, RGB values in an image, etc. For example, a feature may include a statistic (e.g., mean, median, range, maximum, variance mode, etc.) across each of one or more axes in an optical-density or RGB space. As another example, a feature may characterize a spatial contrast of intensities (e.g., where the contrast correlates with an amount of and/or a degree to which intensities differ across neighboring or nearby pixels). The features may be clustered using a clustering technique (e.g., k-means, hieratical clustering or density-based spatial clustering of application and noise (DBSCAN)). For example, k-means clustering may be used when the number of clusters is defined (e.g., to equal a number of stains applying to a scenario or a the number of stains plus one or more other categories, such as a blank-signal category). Such a clustering algorithm partitions the feature space into clusters. Ideally, such clusters may be well isolated from each other and compact, and features of images associated with each given type of stain may be clustered together. A performance-prediction score (or a contributing component thereof) can be based on a degree to which clusters are separated in a feature space, a degree to which synthetic singleplex images corresponding to a given color vector/stain are clustered together, and/or a degree to which images assigned to a given cluster are close together in the feature space. Such degree(s) may be quantified using (for example) a silhouette score, Davies-Bouldin index, or distance (e.g., Euclidean distance, Mahalanobis distance or Manhattan distance).

A performance-prediction score may additionally or alternatively be based on an estimated correlation between one or more synthetic singleplex images and a corresponding multiplex image. The correlation may be estimated in an RGB space, optical density space, feature space, etc. This approach can account for variation in staining protocol, image acquisition settings and tissue characteristics, thereby providing a consistent basis for comparison. With respect to the optical-density space, values inherently range from non-negative to positive, thereby aligning well with the physical constraints of staining intensities.

For unmixing, in one aspect of the present disclosure, constraints may be introduced to simplify the stain analysis, thus reducing complexity involved in stain unmixing. This may facilitate higher accuracy, precision and/or reliability for the generation of synthetic singleplex images from a given multiplex image. Each pixel of a multiplex image may be mapped to a position within a multi-dimensional color map. Pixels within a specific portion of the color map (e.g., a quadrant, a portion defined by a greater than/less than y-value and a greater than/less than x-value, wedge, etc.) can be assigned characterized as depicting a signal that corresponds to only a single particular stain. For example, in an optical density space, a given angular range may be defined to be associated with a particular stain. For each pixel associated with a position within the angular range, it may be inferred that the pixel depicts expression of a given stain. Further, an intensity of the stain may be estimated based (at least in part) on a distance of a position of the pixel representation from the axis. For pixels outside of the angular range, an unmixing technique may predict expression levels for other biomarkers, maintaining a predefined expression level e.g., a “0” or other predefined number for the first biomarker.

To facilitate extracting a specific portion from the color space, the GUI may provide a set of tools to interactively define portions of a multi-dimensional space (e.g., an OD space feature space, RGB space, etc.) to be mapped to a corresponding rule about defining a signal component. These tools may be configured to define a region of the multi-dimensional space that corresponds to (for example) a wedge, facet, exterior, cylinder, curves, or oval. Alternatively or additionally, a tool may be configured to receive a free-form input that identifies part or all of a border of a region. As some examples, a wedge tool may be configured to receive input that identifies a central point and an angle; an exterior tool may be configured to receive input that selects one or more points along a boundary of an area to be defined; a brush tool may be configured to receive input corresponding to “painting” directly to the chromatic diagram to define one or more regions in the multi-dimensional space; etc. The tools may also be provided to incorporate thresholding techniques where user can specify thresholds for one or more axes (e.g., one or more polar axes in an OD space or one or more color-channel axes). Once a portion is defined or selected within the color space, a particular processing may be performed for each pixel representation assigned to the portion (or that is not assigned to the portion). For example, when a pixel representation is within the portion of the space, a particular algorithm may be used to translate the coordinates into a predicted intensity of a particular stain that corresponds to the portion. As another example, when a pixel representation is outside the portion of the space, it may be inferred that the pixel does not include a signal from a particular stain associated with the portion (e.g., and unmixing may be performed based on this inference).

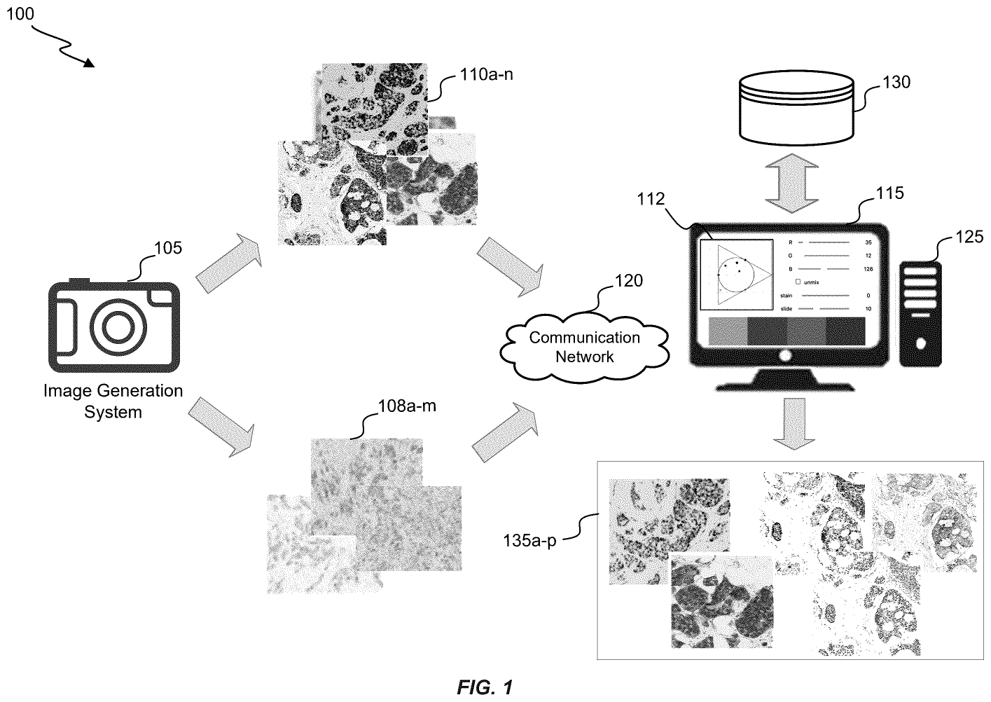

FIG. 1 illustrates a workflow 100 of obtaining and processing multiplex images. An image generation system 105 can be configured to collect images of one or more stained samples. The stained samples may be stained with (for example) one or more biomarker stains and/or one or more reference stains. The collected images may include a pure-color image (where a sample was stained with only one stain), a singleplex image 108a-n (where a sample was stained with a single biomarker stain and a reference stain), or a multiplex image 110a-n (where a sample was stained with two or more biomarker stains and a reference stain). The collected images may be transmitted to a computer system 115 through a communication network 120.

The computer system 115 may process the images to generate one or more outputs 135a-p. In some instances, the computer system 115 receives a multiplex image that depicts a sample stained with multiple biomarker stains (two or more stains or three or more stains) and a reference stain, and the computer system 115 generates outputs that predicts signals from each of at least one of the stains. For example, if a triplex image is received, the computer system 115 may generate an output that includes: one or more synthetic singleplex images corresponding to the biomarker stains used to prepare a sample slice for the image and/or a reference stain used to prepare the sample slice for the image.

The output 135a-p may be generated, for example, using an automated technique and/or using input received via an interface 112. For example, the interface 112 may be configured to dynamically display synthetic singleplex images and/or metrics related thereto generated based on current color vectors assigned to multiple stains represented in an input multiplex image. The interface 112 may also be configured to receive input that directly or indirectly adjusts a color vector for each of one or more of the multiple stains (e.g., thereby triggering an automated update to the interface 112).

The images that are availed to the computing system 115 may include and/or may be transformed (e.g., via the computing system 115) into image data, which may include-for each of one or more pixels-data characterizing one or more intensities (e.g., where each intensity corresponds to a given color channel or a given frequency band). For instance, a biological specimen, for example, a tissue section have been stained by applying a staining assay including one or more chromogenic stains (for brightfield imaging), fluorophores (for fluorescence imaging), quantum dots, or combination thereof. In the analysis of biological specimens, for example, cancerous tissues, different stains are specified to identify one or more types of biomarkers, for example, immune cells.

The communication network 120 may include, internet, an intranet, a wired LAN (local area network), a wireless LAN (WLAN), a WAN (wide area network), a MAN (metropolitan area network), a PSTN (public switched telephone network) and other types of communication networks. The communication network 120 may further include communication devices such as one or more gateways, routers, or bridges. Merely by way of example, the communication network 120 can have one or more servers and one or more web-sites accessible by users to send and receive information usable by the one or more computer systems 115. The communication network 120 may be any type of network familiar to those skilled in the art that can support data communications using any of a variety of available protocols, including without limitation TCP/IP (transmission control protocol/Internet protocol), SNA (systems network architecture), IPX (internet packet exchange), AppleTalk®, and the like.

The computer system 115 of the exemplary system 100 may include a processing system 125 with one or more high-speed central processing unit(s) (CPU), processors and one or more memories. The computer system 115 may also include a memory for storing processing modules or logical instructions that are executed by the one or more processors coupled. The computer memory that stores data may also be maintained on a computer readable medium including magnetic disks, optical disks, organic memory, and any other volatile (e.g., random access memory (RAM)) or non-volatile (e.g., read-only memory (ROM), flash memory, etc.) mass storage system readable by the CPU. The computer readable medium may include cooperating or interconnected computer readable medium, which exist exclusively on the processing system or can be distributed among multiple interconnected processing systems that may be loc-al or remote to the processing system.

One or more databases 130 may store images collected by the image-generation system 105 and/or one or more image-processing results (e.g., synthetic singleplex images and/or synthetic multiplex images).

The computer system 115 may include a client terminal in communication with one or more servers, or personal digital/data assistants (PDA), laptop computers, mobile computers, internet appliances, one or two-way pagers, mobile phones, or other similar desktop, mobile or hand-held electronic devices. The client terminal may be configured to transmit and/or receive information to one or more client systems. For example, the client terminal may provide an interface through which input is received to that partly or fully defines one or more color vectors or other components of an unmixing protocol. The interface may further or alternatively display representations of one or more received images (e.g., in an optical density space) and/or one or more synthetic images (e.g., generated using a set of color vectors, which may have been generated at least in part using input received via the interface).

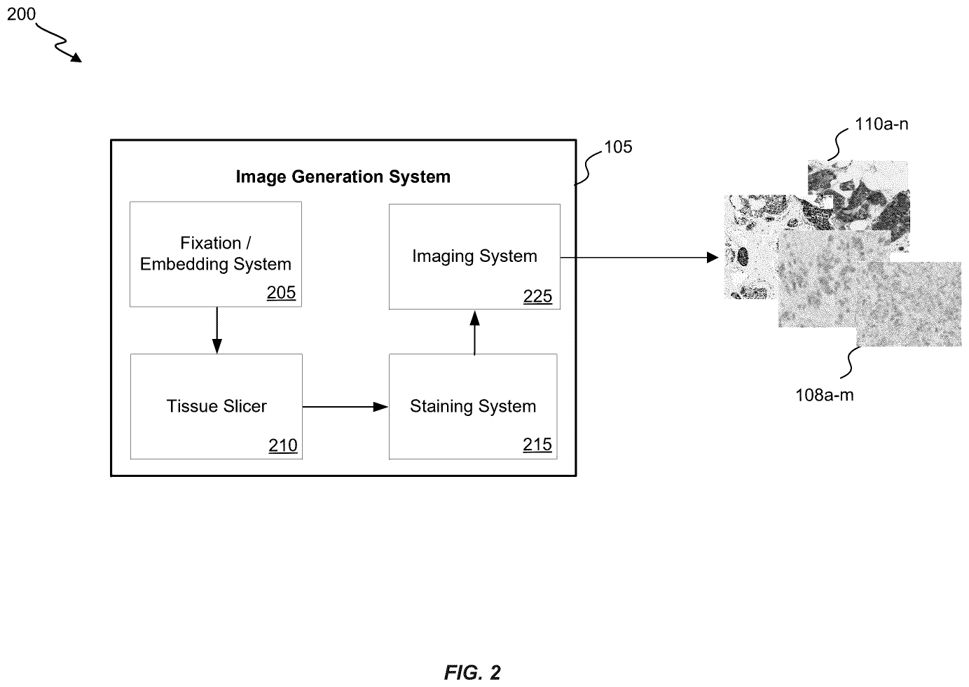

FIG. 2 shows an exemplary network 200 of a digital pathology image generation system 105 from the FIG. 1. The image generation system 105 may include a fixation/embedding system 205 that fixes and/or embeds a tissue sample (e.g., a liquid fixing agent, such as formaldehyde solution) and/or an embedding substance (e.g., a historical wax, such as paraffin wax and/or one or more resins, such as styrene or polyethylene). Each slice may be fixed by exposing the slice to a fixating agent for a predefined period of time (e.g., at least 3 hours) and by then dehydrating the slice (e.g., via exposure to an ethanol solution and/or a clearing intermediate agent). The embedding substance can infiltrate the slice when it is in liquid state (e.g., when heated).

The image generation system 105 may further include a tissue slicer 210 that slices the fixed and/or embedded tissue sample (e.g., a sample of a tumor) to obtain a series of sections, with each section having a thickness of, for example, 4-5 microns. Such sectioning can be performed by first chilling the sample and then slicing the sample in a warm water bath. The tissue can be sliced using (for example) a vibratome or compresstome.

Because the tissue sections and the cells within them are virtually transparent, preparation of the slides typically includes staining (e.g., automatically staining) the tissue sections to render relevant structures more visible. In some instances, the staining is performed manually. In some instances, the staining is performed semi-automatically or automatically using a staining system 215.

The staining can include exposing an individual section of the tissue to one or more different stains (e.g., consecutively, or concurrently) to express different characteristics of the tissue. For example, each section may be exposed to a predefined volume of a staining agent for a predefined period of time. The staining agent can include (for example) an RNA probe, protein probe (e.g., nuclear-protein probe or cytoplasm-protein probe), an immunohistochemistry stain, a probe for a secreted substance, etc. In some instances, the staining agent is one that stains for KAPPA mRNA or LAMBDA mRNA.

One exemplary type of tissue staining is histochemical staining, which uses one or more chemical dyes (e.g., acidic dyes, basic dyes) to stain tissue structures. Histochemical staining may be used to indicate general aspects of tissue morphology and/or cell microanatomy (e.g., to distinguish cell nuclei from cytoplasm, to indicate lipid droplets, etc.). One example of a histochemical stain is hematoxylin and eosin (H&E). Other examples of histochemical stains include trichrome stains (e.g., Masson's Trichrome), Periodic Acid-Schiff (PAS), silver stains, and iron stains. The molecular weight of a histochemical staining reagent (e.g., dye) is typically about 500 kilodaltons (kD) or less, although some histochemical staining reagents (e.g., Alcian Blue, phosphomolybdic acid (PMA)) may have molecular weights of up to two or three thousand kD. One case of a high-molecular-weight histochemical staining reagent is alpha-amylase (about 55 kD), which may be used to indicate glycogen.

Another type of tissue staining is immunohistochemistry (IHC, also called “immunostaining”), which uses a primary antibody that binds specifically to the target antigen of interest (biomarker). IHC may be direct or indirect. In direct IHC, the primary antibody is directly conjugated to a label (e.g., a chromophore or fluorophore). In indirect IHC, the primary antibody is first bound to the target antigen, and then a secondary antibody that is conjugated with a label (e.g., a chromophore or fluorophore) is bound to the primary antibody. The molecular weights of IHC reagents are much higher than those of histochemical staining reagents, as the antibodies have molecular weights of about 150 kD or more.

The sections may then be individually mounted on corresponding slides, which an imaging system 225 can then scan to generate raw multiplex and/or singleplex digital-pathology images (e.g., 110a-n, 108a-m). Each section may be mounted on a slide, which is then scanned to create a digital image that may be subsequently evaluated using automated digital pathology image analysis and/or using input from a human pathologist (e.g., using image viewer software). The input and/or result from the automated analysis may identify (for example) an annotation that identifies one or more segments corresponding to a physiological category (e.g., tumor area, necrosis, etc.). Additionally or alternatively, the input and/or result may identify part or all of a color vector or related variable to facilitate unmixing for a same or different slide.

A digital histopathology image (e.g., 110 or 108) typically includes an array, usually a rectangular matrix, of pixels. Each “pixel” is one picture element and is a digital quantity that represents some property of the image at a location in the array corresponding to a particular location in the image. If the digital pathology image is a gray-scale image, pixel values for a digital image typically conform to a specified range. For example, each array clement may be one byte (e.g., eight bits) representing pixel values in the range of 0 to 255. In a gray scale image, a “255” may represent absolute white and zero (‘0’) an absolute black (or visa-versa). Color images may comprise of multiple (e.g., three) color channels, such as red, green, and blue (RGB) channels. For a particular pixel, there is typically one value for each of these color channels, (e.g., a value representing the red component, a value representing the green component, and a value representing the blue component). By varying the intensity of these three components, all colors in the color spectrum are typically created. It will be appreciated that, in some cases, a digital histopathology image includes signals corresponding to one or more wavelengths outside the visible spectrum (e.g., in an ultraviolet spectrum or infrared spectrum).

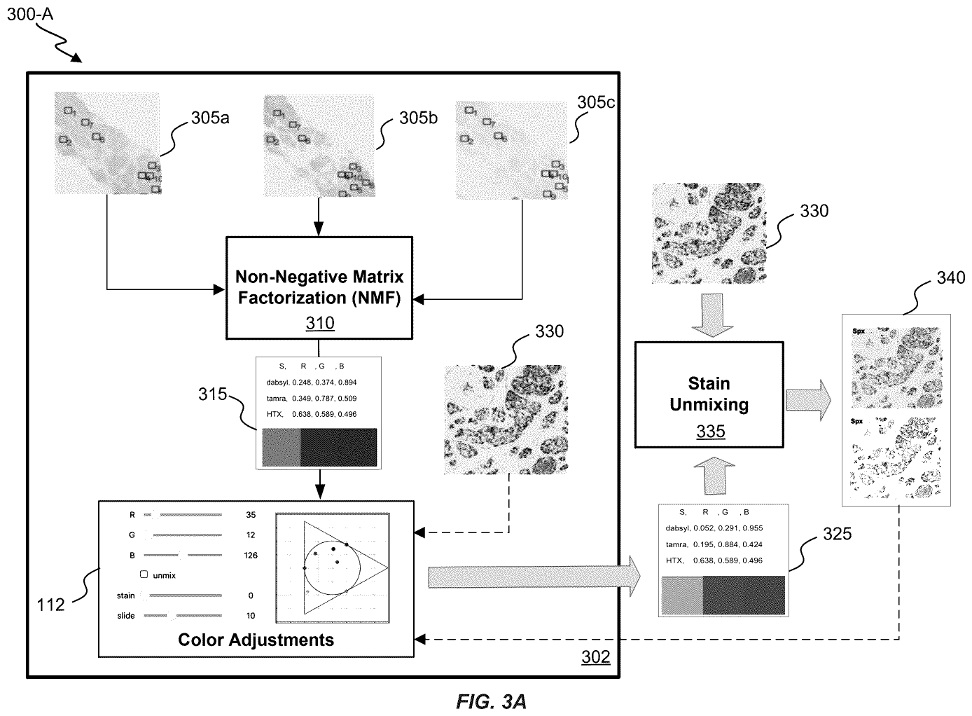

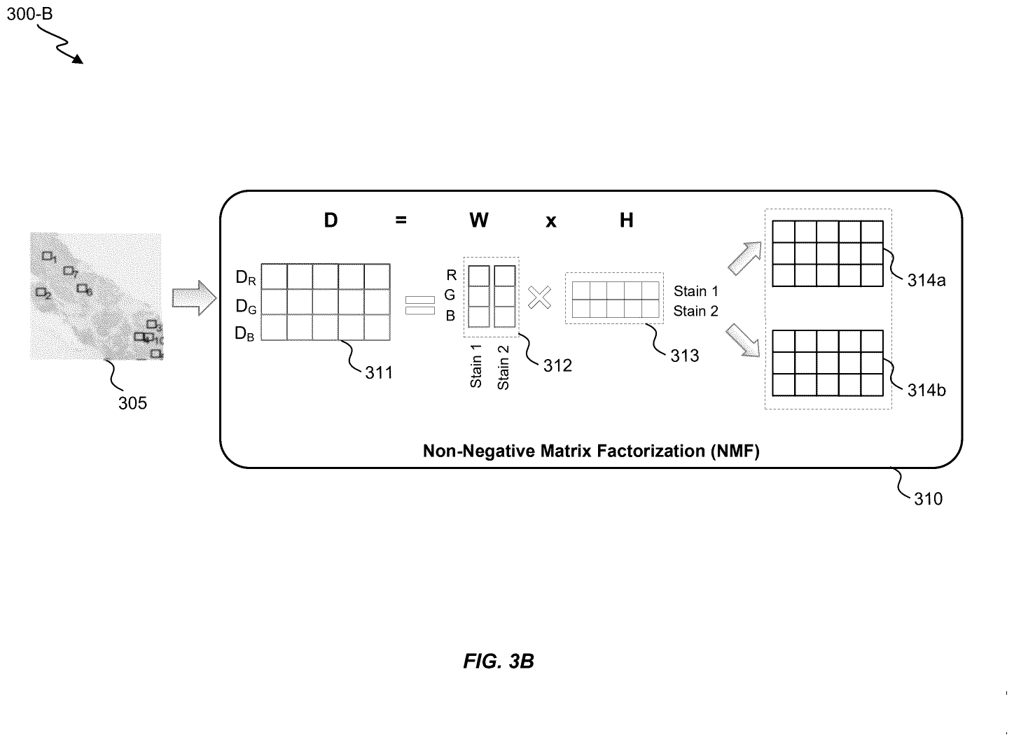

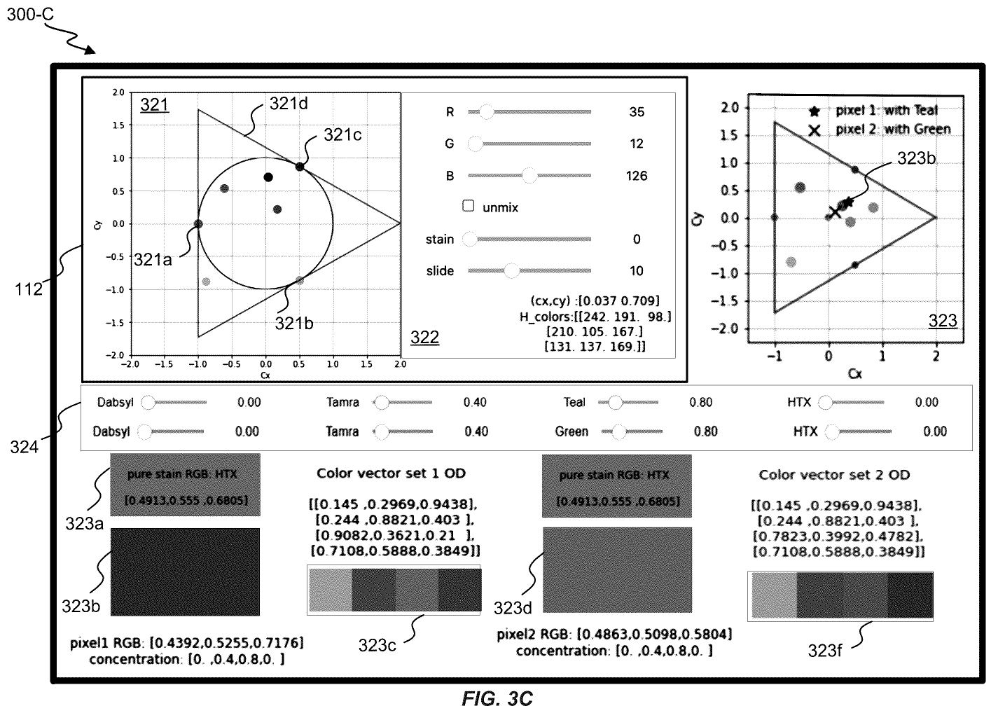

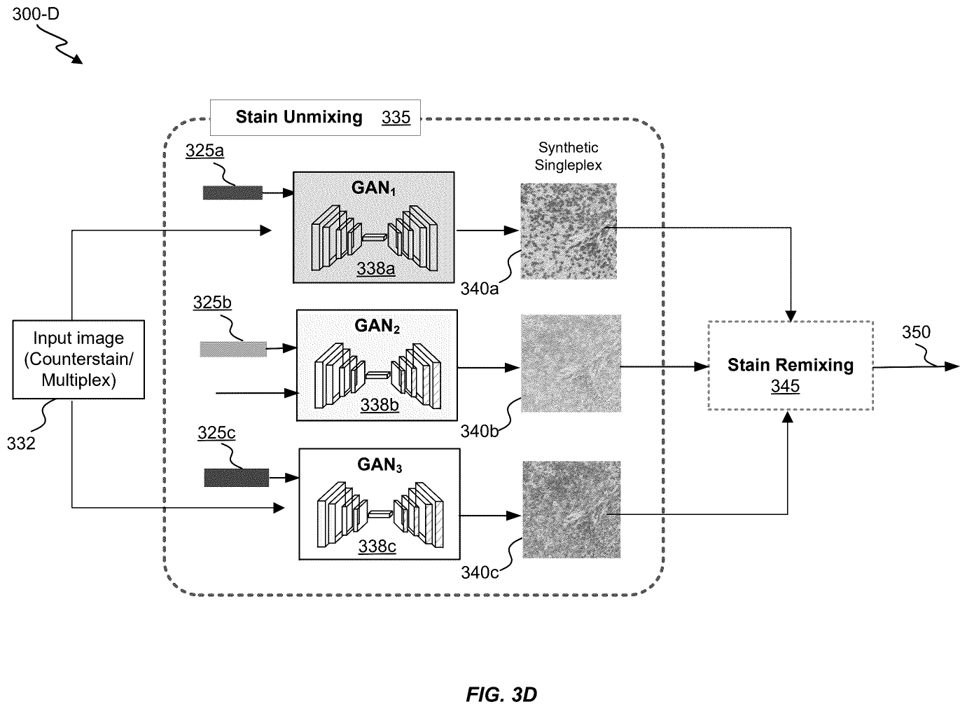

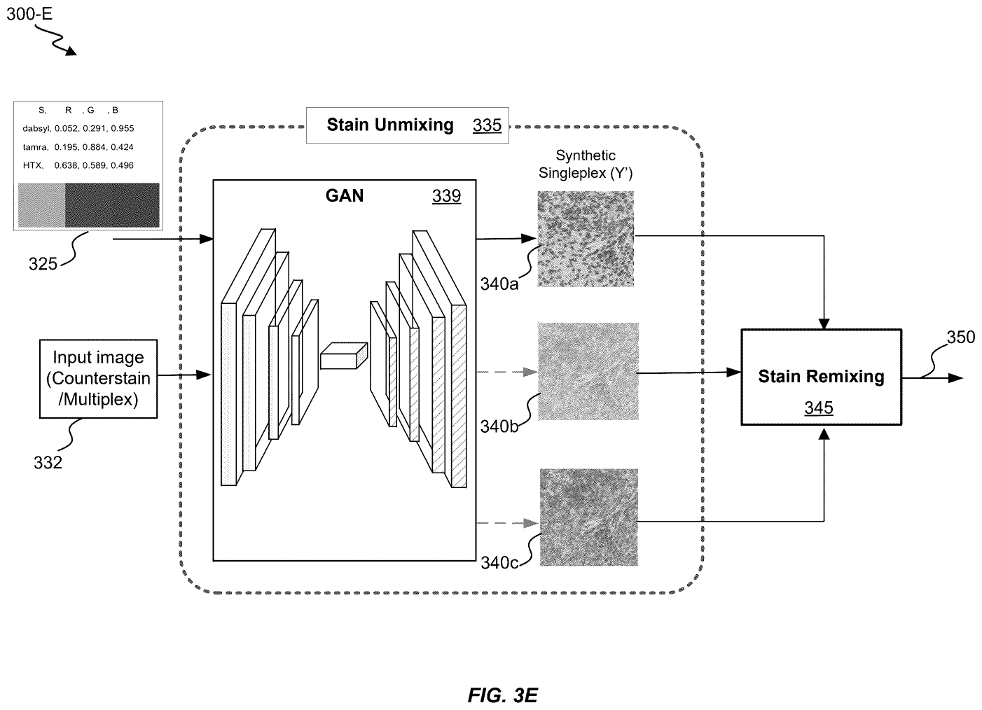

FIG. 3A illustrates an exemplary workflow 300-A to define a color vector associated with a stain from a digital pathology image and perform stain unmixing using the color vector. At block 302, one or more color vectors associated with one or more corresponding stains are defined and/or adjusted. One or more single-stain (or pure-color) slides (e.g., slides 305a, 305b and 305c) are accessed.

The pure-color stained slides 305 may be the IHC images that depict a slide stained with a single stain without a counterstain, stained by replacing a buffer solution in the other primary biomarkers in a multiplex IHC staining protocol. A user interface may present one or more of slides 305a-c and may receive user input that identifies one or more regions of interest in a given depiction of a given at least part of a slide.

As an illustrative example, FIG. 3A depicts three pure-color stained slides (a single yellow stain (Dabsyl) 305c, single purple (TAMRA) 305b, a single blue (Hematoxylin) 305a). These pure-color images 305 may also include one or more markers overlaid at corresponding particular position(s) within the images. This overlaying may provide reference points by strategically placing markers at positions that are likely to provide pure stains or representative regions of interest within the image. These positions may be selected based on prior knowledge of the staining process, tissue characteristics, user input, or through empirical observation of image features. The color vectors may be defined based on these particular positions.

The pure-color stained slides 305 may be processed using a linear technique, such as non-negative matrix factorization (NMF) 310 that may result in two non-negative matrices. In this technique, the pure-color stained RGB images (e.g., 305a-c) may be transformed to an optical density (OD) domain based on Beer-Lambert's law. According to this law, the optical density is linearly related to stain concentration. Following this law may result in a two-dimensional (2D) matrix (D) that may be further factorized by NMF 310 technique to find the initial color vectors 315 associated with the marker positions. Mathematically, this can be expressed in matrix form as, D=WH. For the staining applications, D is the optical density matrix, W is the non-negative basis matrix also termed as “color vectors” matrix and H is the non-negative coefficient matrix also termed as stain intensity matrix. For an RGB stained image, the columns of W matrix may correspond to initial color vectors 315 of each constituting stain based on the particular positions.

A color vector (e.g., of size (1×3)) derived from the pure-color staining slides may correspond to the representation of a single color in a three-dimensional color space, such as RGB. For example, for Dabsyl stain, the extracted color vector may have an RGB composition of [0.248, 0.374, 0.894]. A matrix W derived from a multiplex image such as a duplex may be of the size of (3×3) with two stains and one counterstain or for a triplex W may be of size (3×4). The initial color reference matrix W obtained from NMF 310 may end up not performing well to unmix the stains of a given multiplex image 330. It may cause errors (e.g., white spaces or faded counterstain hematoxylin) or the presence of background noise after unmixing a multiplex image 330 from the initial color vectors 315. It may be understood that the initial color vectors 315 arranged in columns make up the initial reference matrix W. To mitigate errors in initial color vectors 315, a calibration of initial color vectors may be performed. The calibration may be performed to identify adjusted color vectors that produce synthetic singleplex images and/or synthetic multiplex images of high quality. To this end, an interactive graphic user interface (GUI) 112 and/or automated technique may be provided to facilitate fine-tuning of one or more initially defined color vectors 315, as illustrated in FIG. 3A. For reference, a real multiplex image 330 may also be provided in the interface 112 for fine-tuning of initial color vectors. The interface 112 can receive user input that defines or adjusts one or more color vectors, which results in dynamically defining or dynamically adjusting the color matrix W. As illustrated in FIG. 3A, though the interface 112 may be configured such that a user fine-tunes a color vector by adjusting a contribution of a given color channel (e.g., a red, green or blue channel), the interface 112 may also show a representation of each of one or more color vectors in an optical density space.

Using the color matric W, one or more synthetic singleplex images 340 are dynamically generated from the real multiplex image 330 or from a different multiplex image. The synthetic singleplex images 340 can be displayed on the interface 112 and dynamically updated as the color vectors 325 are adjusted. Once the fine-tuning is completed, the color vectors 325 may be locked and used to carry out stain unmixing 335 of a same or different multiplex image.

In some instances, stain unmixing 335 can be performed linearly, such as by using NMF technique that leverages the updated color matrix W 325 and the stain coefficient matrix H of the input (same or different) multiplex image 330 thereby generating synthetic singleplex images 340. Alternatively, it can be performed non-linearly (e.g., by leveraging machine-learning models that are explained hereafter in reference to FIGS. 3D and 3E).

FIG. 3B illustrates an exemplary linear unmixing technique in accordance with some embodiments of the present disclosure. Such a technique may be used to extract initial color vectors 315 from given pure slides and/or to perform stain unmixing 335. The particular linear unmixing technique illustrated in FIG. 3B is non-negative matrix factorization (NMF) 310. NMF 310 may be performed in the optical density (OD) domain, where the colors/stains are represented as absorbance values rather than raw RGB pixel values. Thus, a preprocessing may be performed to convert-for each pixel in an image-RGB intensities into OD values. Processing OD values is then based on the physical properties of light absorption by the different stains or fluorophores present in the sample, leading to more accurate and meaningful results.

To transform real/synthetic RGB images (e.g., IHC pure stain images such as 305a-c) to OD domain, it may be assumed that the stained images are light absorbing and satisfying Beer-Lambert law. The Beer-Lambert law states that the intensity of light absorbed or transmitted through a medium is proportional to the thickness of the medium and concentration of the transmitting material. Mathematically, Lambert's law can be formulated for the intensity of light (I) after passing through the medium as: I=I₀·e^{-αcd}, where I₀ is the initial intensity of the light before entering medium, α is the absorption coefficient of the medium, c is the concentration of the absorbing material or the amount of stain per unit area, and d is the thickness of the medium. In the context of digital IHC images (e.g., 305) each color channel (e.g., red, green and blue) will have light intensities (I_{R}, I_{G}, I_{B}) with the respective values for absorption coefficients of the sample, concentrations of the staining in the sample, and thicknesses of the sample. Therefore, Lambert's law may be applied separately to each color channel describing how each color component is attenuated differently when light passes through the medium resulting in the final color appearance of the multiplex image.

Lambert's law signifies an exponential (or non-linear) relationship between the intensity of light (I) passing through a medium with the product of c, α, and d. Due to the non-linear relationship, the intensity values of RGB (digital) images cannot be directly used for unmixing each stain. To simplify data analysis and interpretation, calculations may be performed in the optical density domain, which avails linear relationships and a compression of dynamic range when the range of intensities are large. Optical density (OD), often denoted by D, is a measure of how much a material attenuates light. It may be formulated as:

$$D = - {log}_{10} ( \frac{I}{{I}_{0}} ) = α . c . d ,$$

showing a direct relationship between optical density with variables α, c, and d. A higher OD value may suggest a greater amount of staining in the sample. For each color channel, an OD vector may be formed such that D={D_{R}, D_{G}, D_{B}}.

NMF 310 operates under the assumption that the observed colors/stains in an image are a linear combination of color/stains of the individual components. This assumption allows for the separation of mixed stains using a linear transformation. NMF utilizes iterative optimization algorithms to factorize the observed data matrix into non-negative matrices that represent the spectral signatures (basis matrix) and abundance maps (coefficient matrix) of the components.

Using NMF can be advantageous (e.g., over using other linear techniques), in that (for example) NMF uses intuitive non-negative constraints that align well with the physical constraints of stain intensities in pathology images. Further, given that NMF uses basis vectors representing pure stains, the results are interpretable. NMF also is configured in a manner to flexibly accept constraints or prior knowledge and to be robust to noise and staining variations.

In NMF 310, the obtained data matrix is in optical density domain e.g., D∈ [symbol] ^{d×m} 311, where d is the dimension of each data point (e.g., for RGB image, this value is 3) and m is the number of data points, and it is assumed to be a non-negative matrix. In other words, for each pixel, there is an RGB composition in OD space. This matrix can be decomposed into a color vector matrix 312 (W∈ [symbol] ^{d×k}) and a stain intensity matrix H∈ [symbol] ^{k×m} 313, where k≤min{d,m} is the desired rank of the matrix D 311 that represents the number of stains. The non-negativity constraint is also imposed on both matrices i.e., W (312) and H (313). Mathematically, D≈W×H, which can be solved by the following optimization problem:

$$\frac{1}{2} {‖ D - WH ‖}_{F}^{2} , s . t . W , H \geq 0$$

where ∥·∥_{F} denotes Frobenius norm.

The color vector matrix 312 and coefficient matrix 313 may be initialized with the aim to achieve convergence to an optimal solution. The initialization may be performed by various techniques, such as random initialization, singular value decomposition (SVD), sparse initialization, k-means, or guided initialization. These techniques may be used individually or in combination, and the choice of the initialization technique may depend on specific characteristics of data and the desired properties of factorization. In NMF 310, the objective function is optimized iteratively using multiplicative update rule. The updates for the basis matrix and coefficient matrix can be formulated respectively as,

$${W}_{ij} ← {W}_{ij} \frac{{( {DH}^{T} )}_{ij}}{{( {WHH}^{T} )}_{ij}} and {H}_{ij} ← {H}_{ij} \frac{{( {W}^{T} D )}_{ij}}{{( {H}^{T} WH )}_{ij}} .$$

To avoid the scale-variance problem and non-unique solution, NMF 310 can be extended to sparse NMF by adding a regularization term and a sparsity term.

For stain unmixing 335, a synthetic singleplex OD image can be reconstructed from the color vector matrix W 312 and stain intensity matrix H 313. For reconstruction of the i^{th} stain, the i^{th} column of W (i.e., Wᵢ) can be multiplied with the j^{th} row of H (i.e., Hⱼ), generating a synthetic singleplex OD image (e.g., 314a). The color vector matrix W 312 (e.g., as defined based on user input) may be used. These singleplex OD images (e.g., 314a and 314b) can be converted to RGB domain, if required. To transform an OD image to an RGB domain, a synthetic/real OD image (e.g., 314a, or 314b) associated with a single stain for a singleplex or multiple stains and convert to respective synthetic/real singleplex RGB images by applying Lambert's law that exponentiates the OD values and performs scaling. The mathematical formulation of conversion can be written as: I=I₀e^{-D}. The conversion can be applied to each pixel to obtain corresponding intensity values for synthetic/real RGB singleplex or multiplex images.

In FIG. 3C, an interface component that facilitates fine-tuning of color vectors is shown. The RGB model may be less useful in fine-tuning process because the information of interest, e.g., the color of the stain (determined by the absorption characteristics), is mixed with variations in the amount of stain. One technique that can be used to extract the chromatic (color) information from the RGB data uses the hue-saturation-intensity (HSI) model. The RGB to HSI transform decouples the intensity information from the color information. In the HSI model, the hue of a color is its angle measured on a color wheel ranging from 0 to 360 degrees. For example, pure red hues are 0°, pure green hues are 120°, and pure blues are 240°. Neutral colors such as white, gray, and black are set to 0° for convenience. The HSI definition of saturation is a measure of purity/grayness of a color, which can be estimated by the ratio of the difference between the maximum and minimum RGB values to the maximum RGB value. In the HSI color model, saturation may be thought of as the distance from the center of the color wheel. Purer colors have a higher saturation value away from center, while grayer colors have a saturation value closer to center.

Intensity is the overall lightness or brightness of the color, defined numerically as the average of the equivalent RGB values i.e., I=(R+G+B)/3. However, a major part of the variation in perceived intensities in transmitted light microscopy may be caused by variations in staining density. Therefore, the hue-saturation-density (HSD) transform was defined as the RGB to HSI transform, applied to optical density values rather than intensities for the individual RGB channels. For a single pixel, measure of OD can be defined as,

$$D = \frac{{D}_{R} + {D}_{G} + {D}_{B}}{3} = c \cdot \frac{( {α}_{R} + {α}_{G} + {α}_{B} )}{3}$$

The RGB to HSD transform may be defined as:

$${c}_{x} = \frac{{D}_{R}}{D} - 1 , {c}_{y} = \frac{{D}_{G} - {D}_{B}}{\sqrt{3} \cdot D} .$$

It may be understood that because the OD is decoupled, the chromatic coordinates of the HSD model are not equal to those of the HSI model. For the HSD model, the resulting cx-cy plane has the property that single points correspond to RGB points with identical ratios between the α_{R}, α_{G}, and α_{B}. Thus, all information regarding the absorption curves is represented in a single plane. In analogy with the HSI model, values for hue and saturation can be calculated from the chromaticity triangle. Because mixtures of stains show a linear pattern in the cx-cy plane of the HSD model.

In the chromaticity plane (cx-cy), the RGB cube may be represented by an equilateral triangle 321d, which limits the extent of the cx-cy coordinates. The cx-cy plane is a 2D coordinate system represented by the equilateral triangle 321d with the center of each side representing a red 321a, green 321b and blue 321c. In this plane, each color vector may be represented as a point within the cx-cy plane, where the location of the point may correspond to the relative proportions of the primary colors (i.e., red, green and blue) in the color vector. For example, if a color vector has a higher intensity of green channel, the corresponding point would be closer to the green center point 321b. By adjusting the location of the color vector in the chromaticity plane 321 via GUI 112, staining characteristic of a stain may be modified. It can also be modified by adjusting the proportions of R, G and B from the slide bars 322.

In one example, a GUI 323 may be configured to blend two or more stain colors synthetically and interactively with different ratios to obtain a targeted stain. The generated synthetic pixel may be displayed in chromaticity plane cx-cy 321 via the GUI 323. Such synthetic color pixels may be generated by picking which chromogens to blend via user interaction from a given list of chromogens. Then, an amount of stain for each chromogen (e.g., relative to the other chromogen(s)) may be set. The stain colors may be blended by adding up the multiplication results of the amount of stain/chromogen and the corresponding color vectors in OD space, which may be then converted back to RGB space for displaying purpose. Since the chromaticity plane cx and cy only represent hue and saturation, the cz value may be needed to determine for transformation back to RGB. This can be done by first finding cz as, cz=1−cx−cy and then calculating, R=cx·cz/cy, G=cz, B=(1−cx−cy)·cz/cy.

As an illustrative example, a user can generate a synthetic pixel 323b in cx-cy plane by first selecting a set of chromogens (e.g., 323c) and then operating the slide bars 324 for setting the relative amount of stain for each chromogen. In FIG. 3C, multiple slide bars 324 are displayed where setting “Teal” to be “0.8” and “Tamra” to be “0.4” and rest of chromogens e.g., Dabsyl and hematoxylin (HTX) to ‘0’ generated the blue colored synthetic pixel 1 323b (marked with a ‘*’ in the GUI 323). Similarly, another pixel 2 323d may be generated for another set of chromogens 323f by setting “Green” to be “0.8” and “Tamra” to be “0.4” from the slide bars 324 The synthetic pixel 2 is marked with a ‘X’ in the GUI 323. A pure hematoxylin stain 323a may also be provided as a reference in the FIG. 3C for fine-tuning of synthetic pixels. It can be observed that the synthetic pixel 2 is visually closer to the pure hematoxylin stain 323a than the synthetic pixel 1. The locations of the blended stain colors in the cx-cy plot show how close the two synthetic pixels are in hue and saturation. Scaling up the amount of stain while keeping the relative ratios of the chromogens may not change the location of the pixels in cx-cy plot but may change the appearance of the synthetic pixel as displayed in the interface, which is consistent with the design of cx-cy space that counts only hue and saturation while keeping density the same.

FIG. 3D illustrates an example architecture 300-D for generating one or more synthetic singleplex images and/or a synthetic multiplex image by leveraging a plurality of machine-learning models. To generate such synthetic images, the architecture 300-D includes a stain unmixing module 335, the color vectors 325 and a remixing module 345. To generate synthetic images, the synthetic chromogen can be controlled by tuning color vectors, and the cell/tissue-level biomarker stain patterns can be generated using a trained machine-learning model to mimic real images. The machine-learning models may include a generative model (such as a generative adversarial network (GAN), diffusion model, or autoencoder) trained to generate a singleplex image for a particular stain. As an illustrative example, the stain unmixing module 335 may include a conditional GAN (cGAN) to generate a synthetic singleplex image conditioned on an input color vector. For example, a separate cGAN (e.g., 338a, 338b and 338c) may be trained for generating individual singleplex images (e.g., 340a, 340b and 340c) corresponding to the specific targeted stains (or synthetic pixels), as illustrated in FIG. 3D. The number of models may depend upon the number of constituting stains of the multiplex image.

In one aspect, this architecture 300-D may be leveraged to generate synthetic images from the synthetic pixels or associated adjusted color vectors obtained using the technique disclosed above. For example, to generate a synthetic singleplex image, a cGAN model (e.g., 338a) may take a counterstain image such as hematoxylin as an input image 332 conditioned on a color vector (e.g., 325a) of the targeted synthetic pixel (stain). The generated singleplex image 340 may be used to validate the correctness of the synthetic pixels for the targeted stains. In another example, the synthetic singleplex images corresponding to the targeted synthetic pixels may be used to generate a synthetic multiplex image. The generated synthetic multiplex image 350 may be displayed concurrently with a real input multiplex image used to generate the synthetic singleplex images 340a-c. A user can then evaluate an extent to which the real and synthetic multiplex images appear to be the same (e.g., versus an instance where some or all of the signals from the real multiplex image are absent from the synthetic multiplex image). This can facilitate quality control and/or additional fine-tuning of one or more color vectors. Further, when the cGAN models 338a-c are approved, they may be used to generate multiplex images thereby creating additional training data for machine-learning models in a faster and cost-effective manner than performing actual staining experiments in the lab. It may also enable the pathologist to have control over different staining conditions, intensities, and suitable combinations of biomarkers in the synthetic multiplex images. These synthetic multiplex images may be tailored to specific needs and applications.

In another instance, each cGAN may receive a real multiplex image (e.g., 330) as an input image 332 and a color vector (e.g., 325a, 325b or 325c) obtained from the module 302. In this setting, the architecture 300-D may be leveraged to filter the real multiplex image in accordance with the adjustment of the color vector. Such a generative model may be trained to filter the given multiplex image, thereby generating an output that includes a predicted signal for the specific stain associated with the model (such a condition is defined for the cGAN based on the color vector of the specific stain). These synthetic singleplex images may be further combined by stain remixing 345 module to generate synthetic multiplex image 350. The synthetic multiplex image 350 may be compared (e.g., computationally, automatically and/or via user review) to the real multiplex image provided as input 332. This comparison can be used during training and/or as an indicator of confidence of a quality of the generated synthetic singleplex images 338a-c. The indication of image quality may be incorporated in GUI 112 as feedback that may inform a user's decision as to whether to further adjust one or more color vectors. It may be understood that the number of generative models shown in FIG. 3D is only for illustrative purposes. The aspects of the present disclosure are intended to include or otherwise cover any number of generative models depending upon the nature of multiplex images.

An example of another approach that uses a single model (e.g., a single cGAN) to generate the one or more synthetic singleplex images 340 is illustrated in FIG. 3E. The single model 339 can be configured to receive, as input, a real multiplex/counterstain image 332 and an identification of a particular biomarker (e.g., by recceing a corresponding color vector e.g., 325a) indicating characteristics of synthetic singleplex image that is being requested. Further, as stated above, the synthetic singleplex images 340 can be combined to produce a synthetic multiplex image 350. A comparison of the synthetic multiplex image 350 to the real multiplex image may be used during training and/or as an indicator of a confidence of synthetic singleplex image quality.

The stain remixing module 345 may combine the synthetic singleplex images (e.g., 340) to generate a synthetic multiplex image 350. The synthetic multiplex image 350 may be generated linearly in optical density (OD) domain that involves merging the intensity values of each pixel from the individual singleplex images 340a-c to create a composite multiplex image. This process can be achieved through various mathematical operations such as addition, subtraction, multiplication, or weighted average, depending upon the desired outcome. Mathematically, it can be formulated as, Dₘᵤₗₜᵢₚₗₑₓ=w₁D₁+ . . . +w_{c}D_{c}, where D₁, . . . , D_{c} represent the OD singleplex matrices (e.g., 314a, 314b), w₁, . . . , w_{c} are the weighting factors assigned to each singleplex image. These weights may control the contribution of each stain to final multiplex image 350.

Alternatively, for stain remixing 345, a generative model such as GAN or an autoencoder can be trained to learn complex mapping between the synthetic singleplex images and the corresponding multiplex counterpart. By training generative models on a dataset comprising input-output pairs (e.g., singleplex images and multiplex image), the model can capture intricate relationship between stains and cell structures. This process may involve learning to fuse the features extracted from individual singleplex images 340 to create a coherent and visually realistic multiplex image. The adversarial loss for training a generator G and a discriminator D to translate synthetic singleplex images 340a-c to synthetic multiplex image 350 may be formulated as:

$${Loss}_{adv} ( G , D ) = \frac{1}{n} {\sum }_{i = 1}^{n} {( 1 - D ( G ( x ) ) )}^{2}$$

where x is a set of synthetic singleplex image (x₁, . . . , x_{c}) 340a-c and n is the number of samples in the training data.

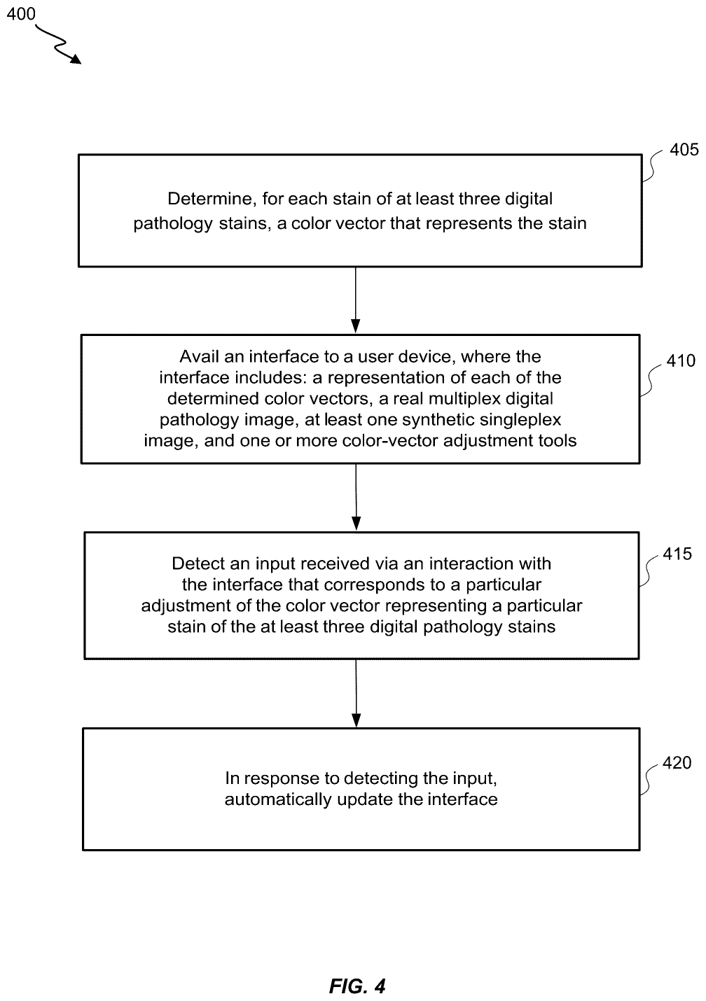

FIG. 4 illustrates a flowchart of an exemplary process 400 that determines one or more color vectors for stain unmixing in accordance with some embodiments of the present disclosure. The process 400 relates to stain unmixing of digital pathology images by finding the initial color vectors 315 and adjusting the color vectors using a graphical user interface (GUI) 112. The process 400 starts at block 405, where color vectors associated with digital pathology stain or colored chromogens (e.g., at least three) are determined. The color vectors may be a default color vector associated with a dye (which may be identified using, for example, a look-up table and/or a predefined variable). For example, a color vector for a “green” dye may be defined as [0,1,0] is an RGB space.

Alternatively, the initial color vectors determined at block 405 may be determined using an initial processing of one or more images received from the user device (or other device associated with the user device). For example, non-negative matrix factorization (NMF) may be performed to transform a given OD matrix into two non-negative matrices e.g., W color vector matrix and H abundance or coefficient matrix. The determined color vectors 315 in W may accurately represent true spectral characteristics of the staining components, though they may alternatively fail to capture such characteristics, due to (for example) noise, artifacts, or limitation of the imaging system. Thus, the interface may provide dynamic data that facilitates fine-tuning one or more color vectors.

At block 410, an interface is availed to a user device. For example, a communication can be transmitted from a server (e.g., a web server) to the user device, where the communication includes code with instructions for generating and displaying the interface on the user device. As another example, local code may be executed to generate and display the interface.

The interface is may include a representation of each of the determined color vectors, a real multiplex digital pathology image, at least one synthetic singleplex image, and one or more color-vector adjustment tools. Each of the at least one synthetic singleplex image may be or may have been generated using the real multiplex digital pathology image and the color vectors determined at block 405. Each of the at least one synthetic singleplex image may be generated by processing the real multiplex image using a technique herein, such as a linear unmixing technique (NMF) or a non-linear unmixing technique (e.g., a machine-learning model). The one or more color-vector adjustment tools may be configured such that, for a given color vector, input can be received that adjusts a contribution or weight associated with each of one or more contributing axes. For example, a color-vector adjustment tool may be configured to include a slider or numeric input that defines a weight that is to be assigned to a given color channel (e.g., a red, green, or blue channel), polar-coordinate channel (e.g., in an optical density space), or channel in another space.

At block 415, an input is detected that corresponds to a particular adjustment of the color vectors represented in the interface. The input my include an interaction with at least one of the one or more color-vector adjustment tools. The input may include (for example) positioning a slider and/or inputting a number that indicates an absolute or relative contribution of a channel (e.g., a color channel) for a given stain representation. For example, an input may include a number or slider position indicating that a given stain is to include 5% of a red channel instead of 0% of a red channel for a “green” dye (where the percentage is absolute or relative to a cumulative percentage across channels). As another example, an input may identify a position within an optical-density space that is to be used as a definition of a color vector for a given stain.

At block 420, in response to detecting the input, the interface 112 may be automatically updated. The automatic update may update a displayed representation of the color vector representing the particular stain. Additionally or alternatively, the update may update one or more synthetic images (e.g., one or more synthetic singleplex images and/or a synthetic multiplex image) using the adjusted color vector. One or more metrics (e.g., that characterizes an absolute or relative statistic pertaining to a singleplex image or multiplex image) may also be updated.

Blocks 415 and 420 may be repeated multiple times (e.g., until input is not received within a threshold amount of time, a session ends, a user indicates that color vectors are finalized/defined, an automated quality-control condition is satisfied, etc.).

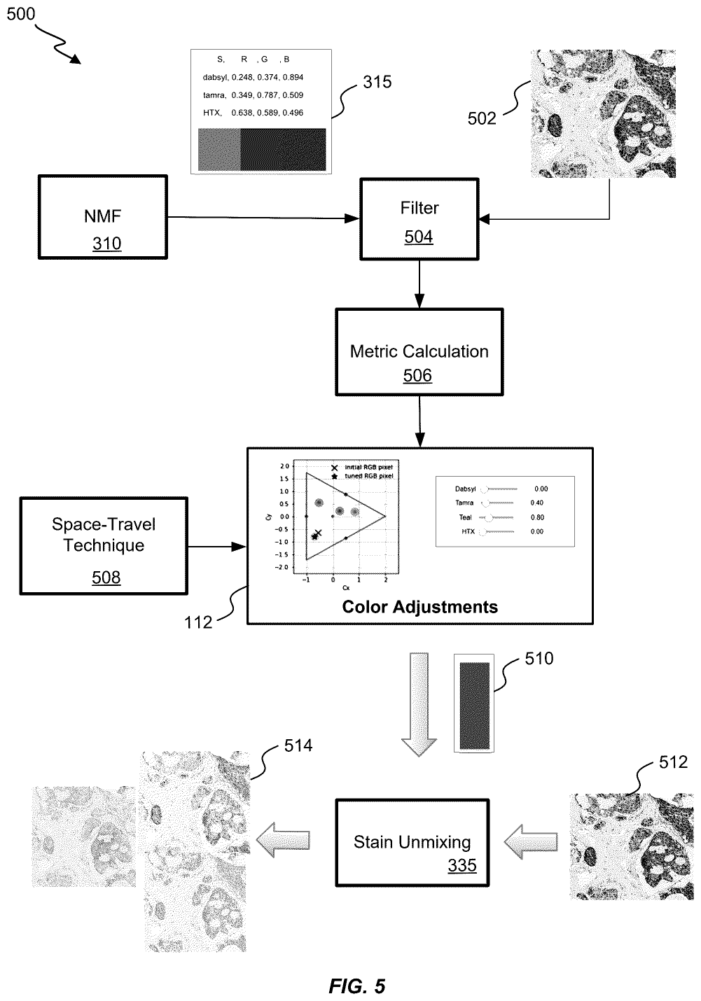

FIG. 5 illustrates an example architecture of a system 500 that determines adjustments of initial color vectors based on a given multiplex digital pathology image in accordance with some embodiments of the present disclosure. The initial color vectors 315 can be determined using an initialization technique (e.g., by leveraging an NMF technique 310) and may find adjustment of the specific initial color vector based on a real multiplex image. In this setting, the real multiplex image 502 may be stained using one or more stains from the initial color vectors 315 but at least one of the initial reference stains may be absent (in that the corresponding slice was not stained with the at least one of the initial reference stains).

The at least one stain that is not represeted in real multiplex image 502 is referred to as “excluded stain” in the ongoing discussion. The initial color vectors 315 may be fed to a filter 504 that is configured to generate a filtered output from the real multiplex image 502 based on the excluded stain. Similar to the process of FIG. 3D, filtering may be facilitated by employing one or more generative models (e.g., autoencoder (AE), image-image translation networks, generative adversarial networks (GANs)) that may be trained to learn the mapping from a given multiplex image to its constituting singleplex images conditioned on a constituting color vector. This approach is motivated by the potential of a well-trained machine-learning model to generate a null (zero) image when conditioned on a color vector that is not present in the input multiplex image 502. This behavior is expected because the model has been trained to understand the relationship between color vectors and the corresponding stains present in the input image. If the model encounters a color vector that is absent in the input multiplex image, it may not be able to generate any meaningful output related to that stain, resulting in a zero or a null image for the excluded stain associated with that color vector.

To assess the quality and characteristics of the filtered output generated by the machine-learning model (filter 504), a metric can be calculated. For example, when it is predicted (or known) that there are no biomarkers corresponding to a given stain (or color vector) in the real multiplex image 502, it could be expected that the mean, median, mode, variance, standard deviation and/or range in a synthetic singleplex image corresponding to the given stain should ideally be very low (or zero). Thus, the metric may be generated in a manner such that the score negatively depends on a statistic (e.g., mean, median, mode, variance, standard deviation and/or range) in a synthetic singleplex image that characterizes a presence of a signal of the corresponding stain in the real multiplex image.

For such a metric, a pixel-cumulatice statistic (e.g., a mean or an average) may be calculated by using the pixel intensity values of a synthetic singleplex image in OD space (e.g., the matrices 314a and 314b in the FIG. 3B) and then dividing by the total number of pixels. Referring to FIG. 3B, if, for example, stain 1 is not present in the matrix 314a, then the corresponding row in H matrix would be approximately zero, thus generating a null image in OD space. Subsequently, the mean for such a synthetic OD space matrix would be lower. Alternatively, a median may be selected by sorting in ascending/descending order all the pixel intensities of the given OD matrix associated with the excluded stain (in this example, 314a), and identifying middle value.

Once the metric is determined, to quantify the filtered output based on the extent to which a stain is present in the real multiplex image 502, a space-traversal technique 508 may be leveraged to find a color vector adjustment 510 associated with the excluded stain. The space-travel technique 508 may systematically explore a space of possible adjustments to the color vector representing the excluded stain. Examples of such techniques may include, but are not limited to, gradient descent, Monte Carlo method, genetic algorithms, or other probabilistic optimization techniques such as simulated annealing that iteratively adjust the color vector to optimize certain criterion such as minimizing the metric calculated. Gradient descent is an optimization algorithm commonly used to minimize a function by iteratively moving in the direction of the steepest descent of the function. In this example, the objective that can be aimed to minimize could be the metric calculated based on the synthetic singleplex image. This algorithm may start with an initial color vector representing the excluded stain and compute the gradient of the metric with respect to the color vector. This gradient indicates the direction of the steepest ascent of the metric. The color vector may be adjusted in the opposite direction of the gradient, scaled by a small step size (learning rate), to minimize the metric. This adjustment is repeated iteratively until convergence, or a stopping criterion is met. An objective may be defined to find the color vector that minimizes the metric, leading to a synthetic singleplex image that accurately represents the excluded biomarker.

Monte Carlo methods are stochastic simulation techniques that use random sampling to estimate numerical results. In this context, Monte Carlo simulation may be used to explore the space of possible adjustments to the color vector representing the excluded stain. Following this technique, random adjustments are made to the color vector representing the excluded stain within a specified range or distribution. The metric is calculated for each randomly adjusted color vector. Depending on the metric value and the optimization objective (minimization or maximization), adjustments may be accepted or rejected probabilistically, guiding the search towards better solutions. This process may be repeated for a number of iterations, allowing for comprehensive exploration of the adjustment space. By iteratively sampling and evaluating adjustments, Monte Carlo methods can efficiently explore the adjustment space and identify promising regions or solutions, which can be incorporated via the interface 112.

Once the color vectors (e.g., 510) associated with the excluded stains are adjusted by minimizing the metric, a new multiplex image 512 may be generated and/or availed. This multiplex image 512 may be stained with the stains associated with initial colors vectors 315 (including the one or more excluded stains for which the color adjustments are computed based on the space-travel technique and metric). By leveraging the stain unmixing process 335 stated before, one or more new synthetic singleplex images 514 may be generated that are associated with the excluded stains.

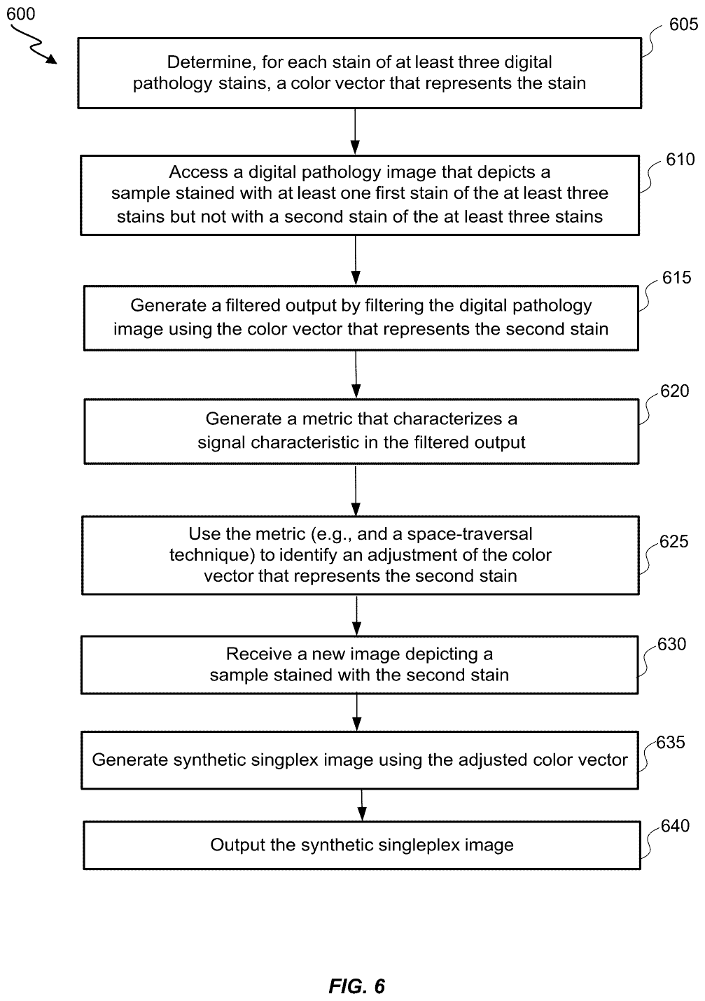

FIG. 6 illustrates an example flowchart of a process 600 for generating synthetic singleplex images using fine-tuned color vectors. At block 605, for each of at least three digital pathology stains, a color vector is determined. The color vector may be determined using a technique described in relation to block 405 of process 400 (or another technique disclosed herein).

At block 610, a digital pathology may be accessed, where the image depicts a sample that is stained using one or more stains associated with the initial color vectors 315 but not with at least one of these stains. Each stain that is not present in sample but that is one of the at least three stains for which the color vectors were determined is referred to as an “excluded stain” herein. The digital pathology may be a multiplex (e.g., duplex) image or a singleplex image.

At block 615, the initial color vectors 315 may be fed to a filter 504 that is configured to generate a filtered output from the digital pathology image based on an excluded stain. The filtering may be performed using a linear technique (e.g., NMF) or nonlinear technique (e.g., a machine-learning model).

At block 620, a metric is generated that characterizes a signal characteristic in the filtered output. Because it is known that the sample depicted in the digital pathology image is not stained with the second stain, an optimal filtered output would include no signal and would be blank. The metric can include any metric that represents whether a signal is present. For example, the metric may include a statistic pertaining to intensity values, such as a mean, median, mode, variance, standard deviation and/or range.

At block 625, an adjusted color vector for the second stain is generated using the metric. In some instances, the adjusted color vector is generated automatically using the adjusted color vector. For example, a space-traversal technique (e.g., gradient descent, Monte Carlo method) may be used, where the filtered output and the metric are dynamically updated as the space is traversed. As another example, an interface and backend system may be configured such that the filtered output and the metric are dynamically updated as a user of the interface adjusts a definition of the color vector for the second stain.

At block 630, a new image is received that depicts a sample stained with the second stain. The sample may, but need not, have also been stained with one or more other biomarker and/or reference stains (e.g., one or more other stains of the at least three stains).

At block 635, a synthetic singleplex image is generated using the adjusted color vector and the new image. For example, the new image can be processed using a linear or non-linear technique to generate the synthetic image. The linear or non-linear or non-linear technique (e.g., and its associated parameters) may be the same used to generate the filtered output at block 620.

At block 640, the synthetic singleplex image is output. For example, the synthetic singleplex image may be transmitted to a user device and/or displayed on a user device. It will be appreciated that, in some instances, multiple synthetic singleplex images are generated and output at blocks 635 and 640, where each synthetic singleplex image is generated using another color vector. In some instances, the other color vector is one that was modified subsequent to the generation of the metric. For example, at block 625, an interface may be configured to dynamically generate and dynamically present the metric (e.g., and a synthetic singleplex image) in response to modifying the color vector that represents the second stain and/or modifying one or more other color vectors that represent one or more other stains of the at least three stains. In some instances, the other color vector is one initially determined at block 605.

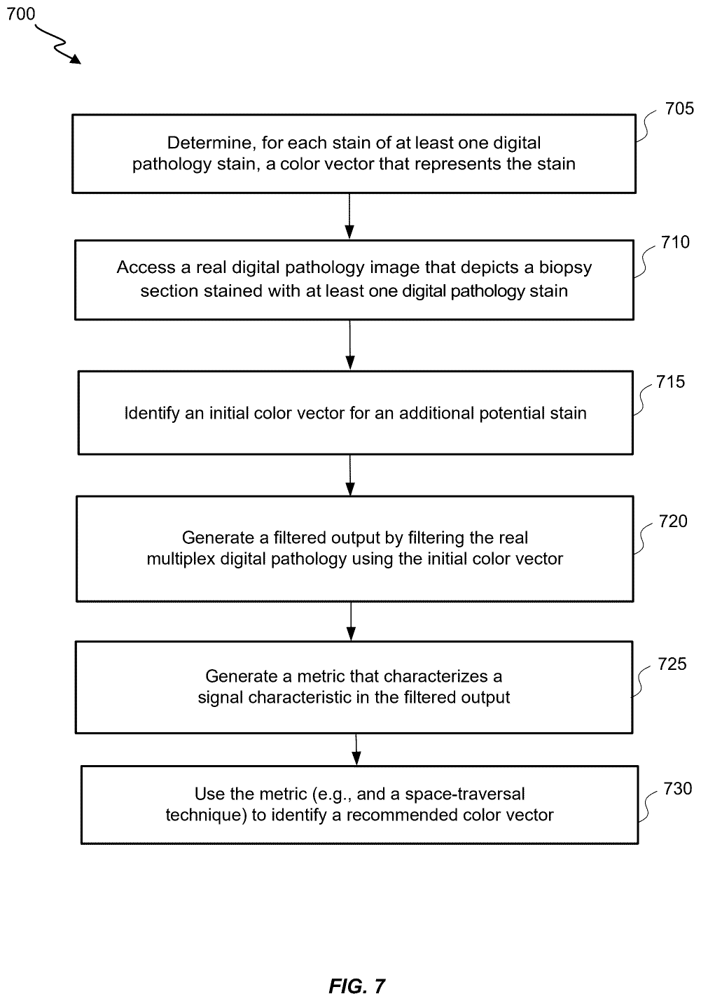

FIG. 7 illustrates an example flowchart of a process 700 to identify a recommended color vector. At block 705, for each of at least one stain, a color vector is determined. The color vector(s) may be determined using a technique described in relation to block 405 of process 400 (or another technique disclosed herein).

At block 710, a real multiplex image is accessed that is stained with the at least one stain associated with the initial color vector(s). For example, a duplex image stained with two biomarker stains along with a counterstain (e.g., hematoxylin) may be accessed. As another example, a singleplex image stained with one biomarker stain and a counterstain may be accessed. An objective can be to identify a potential additional stain that is effectively distinguishable among the existing stain(s), such that (for example) a triplex image using two existing biomarker stains and the potential additional stain can be reliably and accurate unmixed into three synthetic singleplex images.

At block 715, an initial color vector for an additional potential stain can be identified. Such identification may be performed automatically or based on user input. For example, a position for each of the at least one digital pathology stain in an optical-density space can be determined based on the color vectors determined at block 705. An automated technique may identify another position in the optical-density space using an objective function that prioritizes maximizing a distance (or maximizing a minimum distance) in the space relative to the position(s) associated with the at least one digital pathology stain. As another example, an interface may display the positions and/or vectors of the at least one digital pathology stain, and a user input can be received that defines another position and/or vector to be associated with the initial color vector.

At block 720, a filtered output is generated by filtering the real multiplex image using the initial color vector. The filtering may include linear or non-linear filtering. For example, the filtering may use NMF or a machine-learning model.

At block 725, a metric is generated that characterizes a signal characteristic in the filtered output. Because the depicted sample was not stained with the additional stain, an objective function may be defined such that the filtered output lack a signal and/or information. This may indicate that a signal that would be detected via the additional stain nis independent from the at least one stain.

The signal characteristic may characterize (for example) an amount, variation or complexity in the signal. The signal characteristic may include (for example) a mean, median, mode, variance, standard deviation and/or range of intensities; a spatial-contrast metric; etc. The signal characteristic may additionally or alternatively characterize an extent to which the filtered output corresponding to the initial color vector is different than another filtered output corresponding to another color vector (e.g., of the at least one vector).

At block 730, the metric is used to identify a recommended color vector. The color vector may be the same as the initial vector or a different vector. In some instances, the metric is used to determine whether to adjust the recommended color vector. For example, an automated algorithm may be used to iteratively evaluate the metric and adjust the color vector for the additional potential stain until a predefined condition is met (e.g., a target metric is achieved, an iterative improvement for the metric has fallen below an improvement threshold, a predefined number of iterations have occurred, etc.). As another example, the metric and color vector for the additional potential dye may be displayed and dynamically updated in an interface, and user input may be received that adjusts the color vector and may ultimately accept a given color vector for the additional potential stain.

The recommended color vector may be output (e.g., once determined, once accepted, during iterations, etc.). The recommended color vector may be used to inform or select a configuration for the additional potential stain.

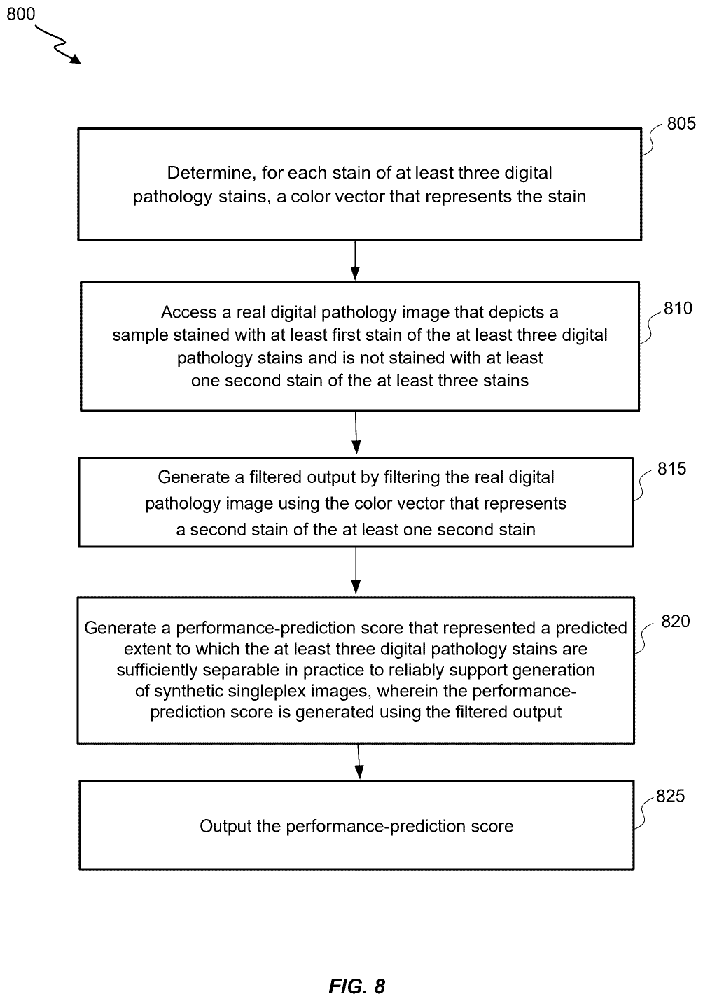

FIG. 8 illustrates an example flowchart of a process 800 of determining a performance-prediction score that represented a predicted extent to which at least three digital pathology stains are sufficiently separable in practice to reliably support generation of synthetic singleplex images.

At block 805, for each of at least one stain, a color vector 315 is determined. The color vector(s) may be determined using a technique described in relation to block 405 of process 400 (or another technique disclosed herein).

At block 810, a real digital pathology image is accessed that depicts a sample that is stained using one or more stains associated with the initial color vectors 315 but not including at least one of these stains (termed as “excluded stains”). The digital pathology image may be (for example) a duplex or singleplex image.

At block 815, the initial color vectors 315 are fed to a filter 504 that is configured to generate a filtered output from the real digital pathology image 502 based on the excluded stain. One or more machine-learning models (e.g., one or more generative models) may be trained to learn a mapping from a given multiplex image to its constituting singleplex images for filtering purpose. As an example, a conditional GAN may be leveraged as a filter such that if the model is conditioned on a color vector absent in the input multiplex image, it may not be able to generate any meaningful output related to that stain, resulting in a zero or a null image. On the contrary, if such a model is given a color vector present in the given multiplex image, it may generate the constituent synthetic singleplex image associated with that color vector.

At block 825, the performance-prediction score is generated for the filtered outputs and/or for other synthetic singleplex images that constitutes the real image. Finally, at block 830, the performance-prediction score is output (e.g., transmitted to and/or displayed at a user device). When it is predicted (or known) that there are biomarkers corresponding to a given stain in a given depicted sample or multiplex image, it could be expected that the performance-prediction score e.g., a mean, median, mode, variance, standard deviation and/or range may be relatively high when accurate color vectors are used as compared to when less accurate color vectors are used. When it is predicted (or known) that there are no biomarkers corresponding to a given stain in a given depicted sample, it could be expected that the mean, median, mode, variance, standard deviation and/or range may be relatively low when accurate color vectors are used as compared to when less accurate color vectors are used. Thus, the performance-prediction score may be generated in a manner such that the score positively depends on a mean, median, mode, variance, standard deviation, range and/or degree to which stains can be effectively distinguished in a synthetic singleplex image when it is known or predicted that there are biomarkers for a corresponding stain in a depicted sample.

In one instance, the performance-prediction score may be estimated by grouping similar stains together based on staining features. For example, staining features may include optical density values, color histograms, or any other feature that may capture staining patterns effectively. These features may be clustered by using a clustering technique e.g., k-means, hieratical clustering or density-based spatial clustering of application and noise (DBSCAN). For example, k-means clustering may be used when the number of clusters is priorly known. Such a clustering algorithm partitions the feature space into clusters, where each cluster represents a group of stained regions with similar staining patterns. The clustering process aims to minimize the intra-cluster (distance between points within the same cluster) and maximize the inter-cluster (distance between points between different clusters) distance. Finally, the performance-prediction score that evaluates the quality of cluster can be estimated by metrics such as silhouette score, Davies-Bouldin index, distance (e.g., Euclidean distance, Mahalanobis or Manhattan), or visual inspection.

In another instance, the performance-prediction score may be calculated for synthetic singleplex images by estimating a correlation between each staining pattern observed in the multiplex image. To this end, correlation coefficient (p) may be calculated for OD singleplex images, derived from RGB, that provides a standardized and quantitative representation of staining intensities by measuring the absorbance of light by the stained tissue. This approach accounts for variation in staining protocol, image acquisition settings and tissue characteristics enabling a consistent basis for comparison. Additionally, OD values inherently range from non-negative to positive, aligning well with the physical constraints of staining intensities. The correlation coefficient between a two singleplex OD images A and B can be computed by finding Pearson correlation as,

$$r = \frac{{\sum }_{i = 1}^{n} ( {A}_{i} - \overline{A} ) ( {B}_{i} - \overline{B} )}{\sqrt{{\sum }_{i = 1}^{n} {( {A}_{i} - \overline{A} )}^{2}} \sqrt{{\sum }_{i = 1}^{n} {( {B}_{i} - \overline{B} )}^{2}}} ,$$

where Aᵢ and Bᵢ are the columns of an OD matrix and Ā, B̅ are their respective means. The absolute value of correlation coefficient ranges from 0 to 1, where 1 indicates a perfect linear relation and a value closer to 0 indicates that the stains are sufficiently separable. This score represents the extent to which stains in synthetic singleplex images are separable and can be used as a measure of the suitability of the synthetic images for various applications such as image analysis, pathology, and medical diagnostics.

The multiplex digital pathology images may represent the intricacy involved in visually inspecting multiple stain intensities that co-localize within a cell. Unmixing of multiplex images becomes further difficult when multiple biomarkers e.g., more than three or four biomarkers are co-localized. For example, an input real/synthetic triplex image may include multiple distinct stains configured to be absorbed by progesterone receptor (PR), human epidermal growth factor receptor (HER) and estrogen receptor (ER). Additionally, the real and/or synthetic multiplex image may include a signal from a counterstain biomarker that is configured to stain nuclei and/or hematoxylin. For staining, PR can be stained with carboxytetramethylrhodamine (TAMRA), HER2 with Green, ER with benzensulfonyl (Dabsyl) and counterstain IHC marker in blue, which is nuclei staining with hematoxylin.

Estrogen is a hormone that can be a contributing factor, particularly in breast and endometrial cancer. Estrogen binds to an estrogen receptor (ER) triggering a series of cellular responses that involve proliferation and differentiation of the specific cells. Estrogen receptors (ER) and Progesterone receptors (PR) are the biomarkers used in cancer pathology to assess the presence of receptors for estrogen and progesterone in tumor cells. ER and PR are nuclear receptors primarily located within the nucleus of a cancer cell. The staining patterns of ER and PR may help identify the subcellular localization of these biomarkers. For ER, a commonly used antibody is ER-α. The stain is usually visualized with a chromogen e.g., DAB. Progesterone staining may involve the use of PR antibodies, and the resulting stain may also be visualized with DAB.

For unmixing, in one aspect of the present disclosure, constraints may be introduced to simplify the stain analysis, thus reducing complexity involved in stain unmixing. This technique may facilitate higher accuracy, precision and/or reliability for the generation of synthetic singleplex images from a given multiplex image depicting a sample stained with e.g., three or more dyes/stains. In the disclosed technique, each pixel of a multiplex image may be mapped to a position within a multi-dimensional color map. Pixels within a specific portion of the color map (e.g., a quadrant, a portion defined by a greater than/less than y-value and a greater than/less than x-value, wedge, etc.) can be assigned a pixel-specific color vector predicting an expression level for a first biomarker corresponding to that portion (e.g., based on a grayscale optical density for the specific portion) and a “0” (or other predefined expression level) for each other biomarker corresponding to the multiplex image. For pixels outside of this specific portion, an unmixing technique may predict expression levels for other biomarkers maintaining a predefined expression level e.g., a “0” or other predefined number for the first biomarker. In some instances, the specific portion may be defined by an inequality with respect to x and y coordinates such as x>25 and y<−15.

For extracting a specific portion from the color space, a GUI may be provided that interactively provides a set of tools to define portions for a multiplex image mapped to the multi-dimensional color space. These tools may include, but are not limited to, wedge, facets, exterior, cylinder, curves, oval, brush tool or a freeform selection. For example, a wedge may allow a wedge shape portion by selecting a central point and an angle; an exterior may allow a selection of points along a boundary of the targeted area; a brush tool may allow painting directly to the chromatic diagram to define portions by adjusting the size and shape of the brush to select areas of interest with varying level of granularity. The tools may also be provided to incorporate thresholding techniques where user can specify thresholds for x and y values for defining portions. Additionally, a freeform tool may provide a flexibility to define a portion where pre-defined shapes may not adequately capture the targeted area. Once a portion is defined or selected within the color space, the GUI may be configured to perform actions such as assigning a specific value to the rest of the portions. The GUI may be configured to provide corresponding matrices to apply unmixing technique (such as the one disclosed) for the rest of the portions where the extracted portion is assigned ‘0’.

In some embodiments, the multi-dimensional color space includes an International Commission on Illumination (CIE) color space also known as CIE XYZ color space. This color space is a standardized system for representing colors based on human perception. It defines three primary colors: X, Y and Z, where Z represents luminance (brightness) and X and Y represents chromaticity (e.g., hue and saturation). For applications such as staining or color analysis, only XY can be used.

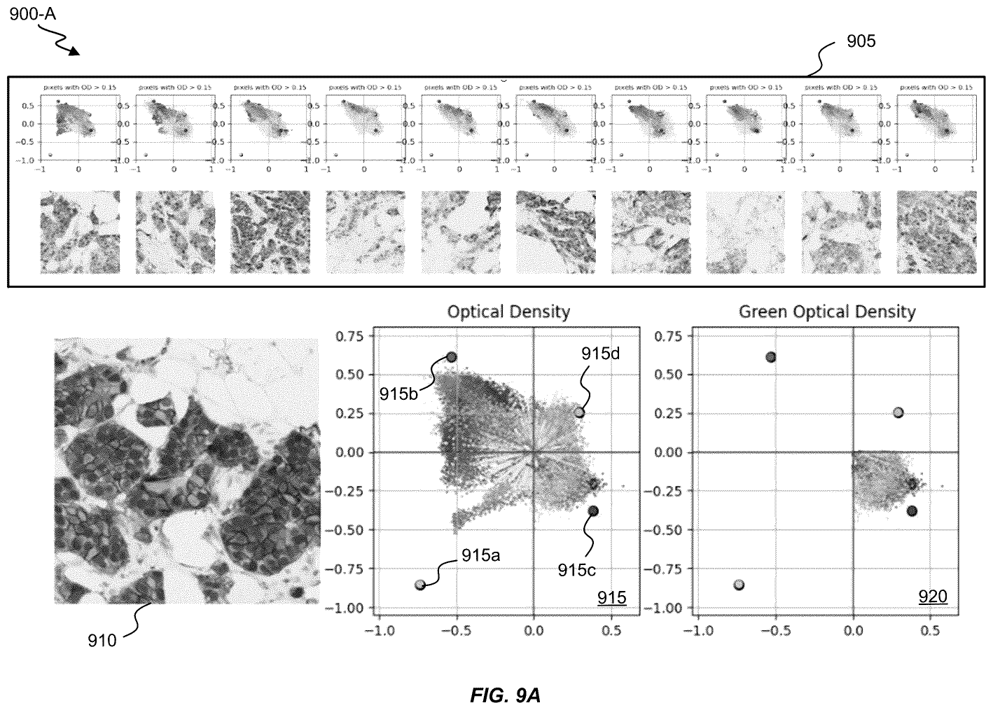

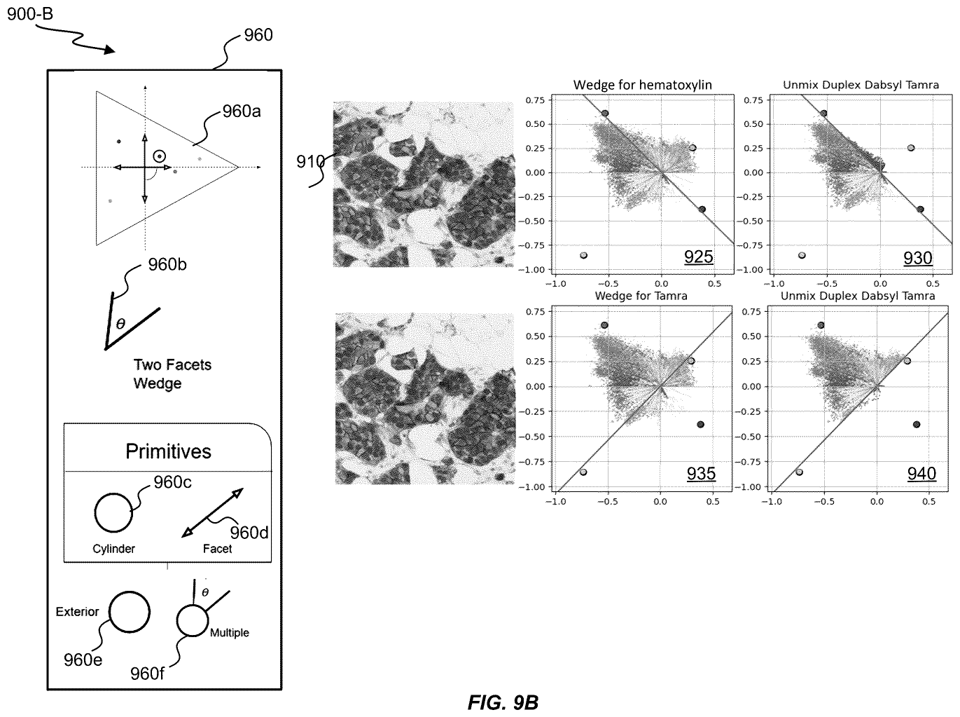

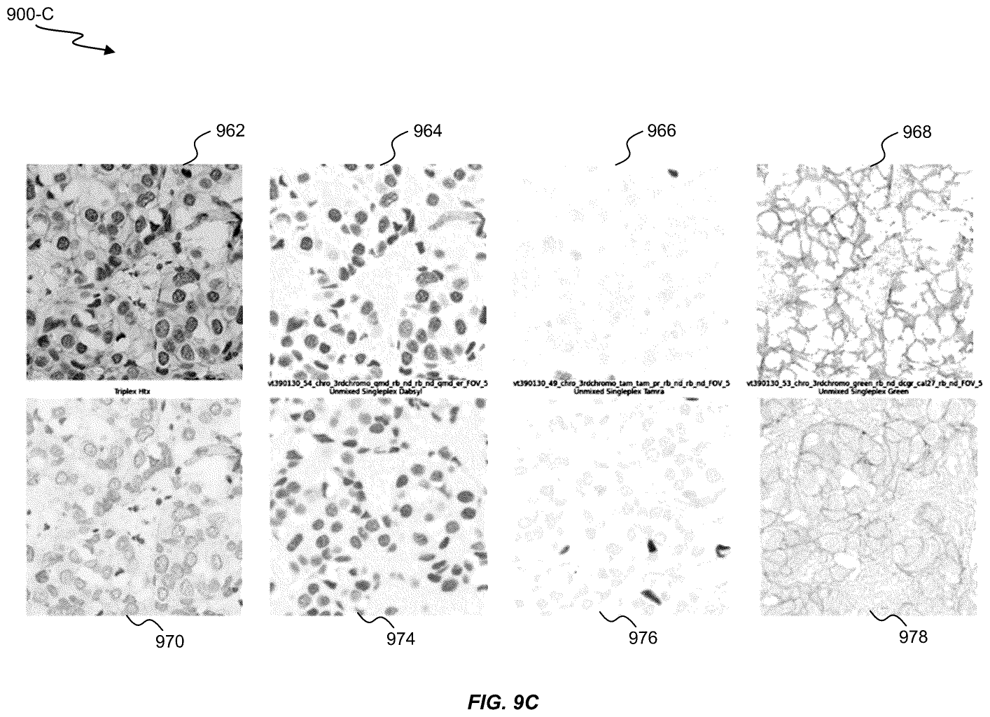

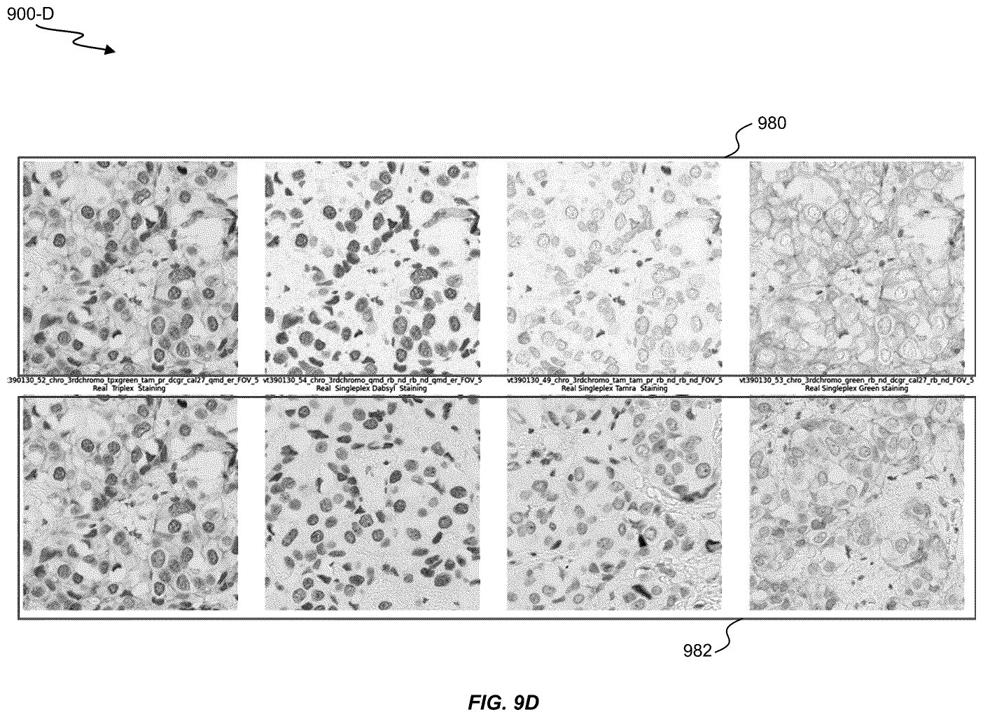

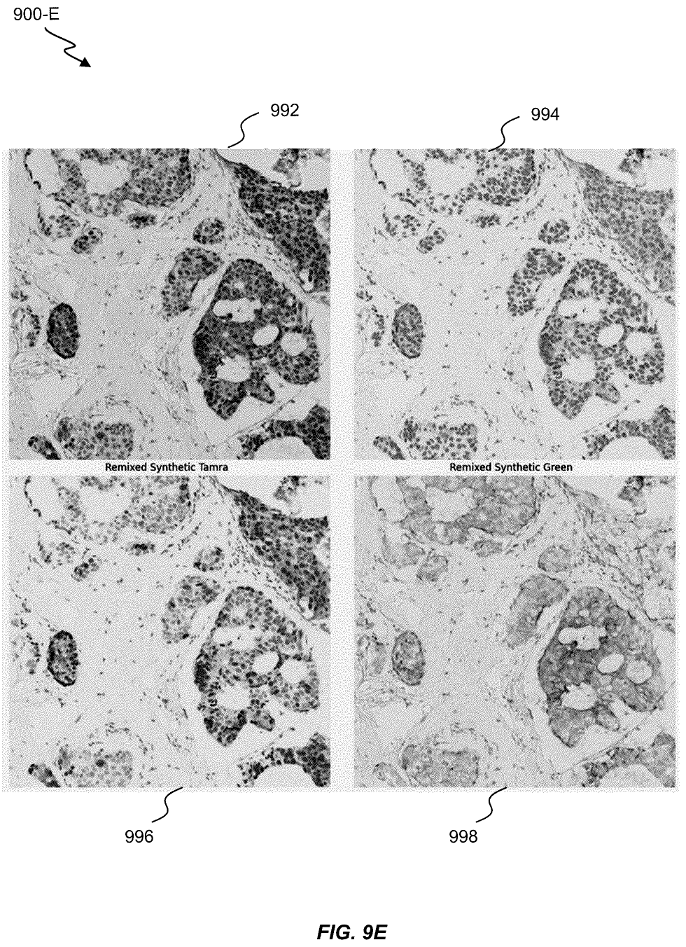

As an illustrative example, FIG. 9A shows examples of ER-PR-HER2 triplex images where each pixel of a triplex image is mapped to a position within a cx-cy plot (being used as a multi-dimensional color map). For the illustration of the disclosed technique, an example of an ER-PR-HER2 triplex image 910 and the corresponding cx-cy plot 915 is shown in FIG. 9A. In the distribution plot 915, the pixels 915a, 915b, 915c, and 915d represent color vectors associated with Dabsyl (ER), TAMRA (PR), Green (HER2) and hematoxylin. It can be observed from the plot 915, that hematoxylin, TAMRA, Dabsyl and HER2 are distributed in the first, second, third and fourth quadrant, respectively. Thus, by leveraging the disclosed constraint method the optical densities of different color distributions can be separated. These extractions may be performed by using different constraints such as linear, cylinder, wedge etc. For example, in the plot 920, only the Green stains are extracted in the fourth quadrant. Following the constraint method, linear or other constraints may be used to extract Dabsyl, TAMRA, and hematoxylin signals from the triplex image 910.

FIG. 9B is an illustration of stain unmixing of the example triplex ER-PR-HER2 image 910 from the FIG. 9A in accordance with some embodiments of the present disclosure. As shown in the cx-cy plot 925 of FIG. 9B, the remaining distributions of ER-PR-HER2 include TAMRA, Dabsyl and hematoxylin thereby resulting in a duplex image. This plot may be achieved by using two-facets wedge 960b from the constraint toolbox 960 that separates the Green from the rest of the stains. In cx-cy plot 930, hematoxylin signals may be extracted from the remaining distributions of ER-PR-HER2 using a facet (line) 960d connecting the color vectors associated with TAMRA pixel 915b and Green 915c. Similarly, in cx-cy plot 935, the remaining distributions are same as that of the plot 925 with a different facet 960d connecting Dabsyl to a hematoxylin. The resulting distributions can be seen in plot 940 that may be achieved by applying the above stated stain unmixing techniques 335. Using the constraint toolbox 960, the distributions can be divided into four quadrants by selecting x-y quadrant separation constraint 960a, as shown in plot 915.

FIG. 9C illustrates examples of stain unmixing results of an ER-PR-HER2 triplex and one or more singleplex images using the disclosed constraint technique. An ER-PR-HER2 triplex image 962 stained with Dabsyl, TAMRA, Green and a counterstain hematoxylin for cell nuclei is shown in FIG. 9C. By leveraging the constraint technique, the triplex image 962 is unmixed into constituting Dabsyl (ER) 964, TAMRA (PR) 966, Green (HER2) 968, and hematoxylin 970 singleplex images. Similarly, a Dabsyl singleplex image 974, a TAMRA singleplex image 976 and a Green singleplex image 978 are unmixed from adjacent registered singleplex in the bottom row of the FIG. 9C using the disclosed constraint technique. These results show that the technique may be effectively used for obtaining stain unmixing for different expression levels of low/medium/high HER2 (Green).

FIG. 9D illustrates examples of stain remixing results of ER-PR-HER2 triplex and one or more singleplex images using the disclosed constraint technique. The stain remixing may be done by the process 345 stated above in the FIG. 3D. The top row 980 shows the remixing results of the ER-PR-HER2 triplex and the bottom row 982 shows the ground-truth triplex image and adjacent registered real singleplex images for the comparison.

FIG. 9E illustrates stain remixing results for a triplex ER-PR-HER2 in accordance with some embodiments of the present disclosure. In this example, the ER-PR-HER2 triplex image 992 is unmixed using the disclosed constraint technique into its constituting chromogens. The disclosed constraint technique may extract individual signals by applying constraints e.g., linear, wedge, cylinder constraints from the provided interface. The extracted stain signals may be then remixed to counterstain hematoxylin to obtain a synthetic remixed Dabsyl 994, synthetic remixed TAMRA 996 and synthetic remixed Green 998, as illustrated in FIG. 9E.

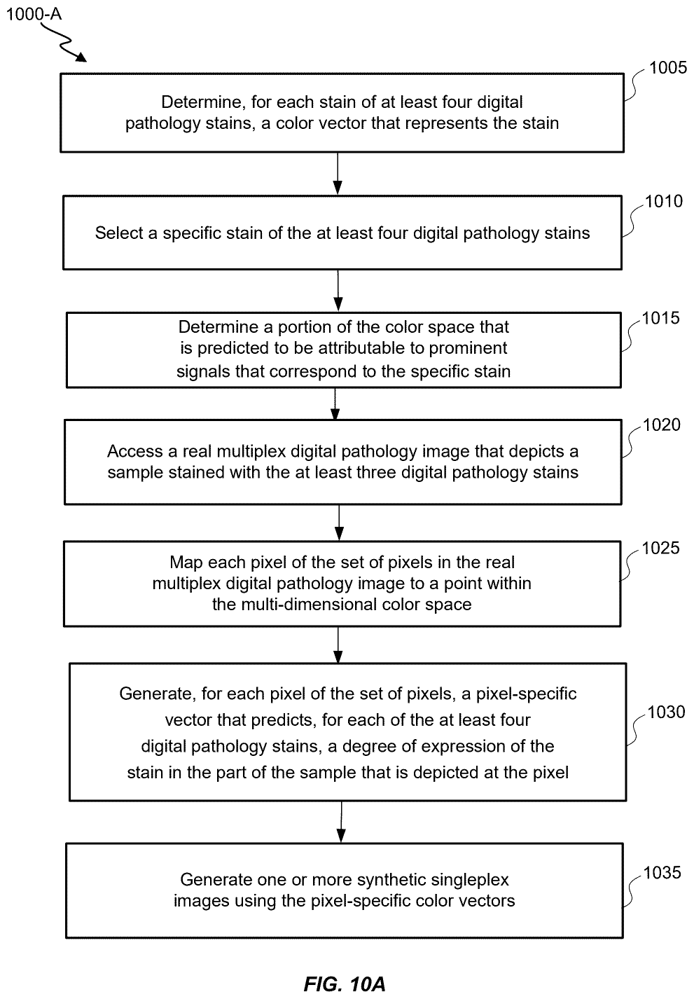

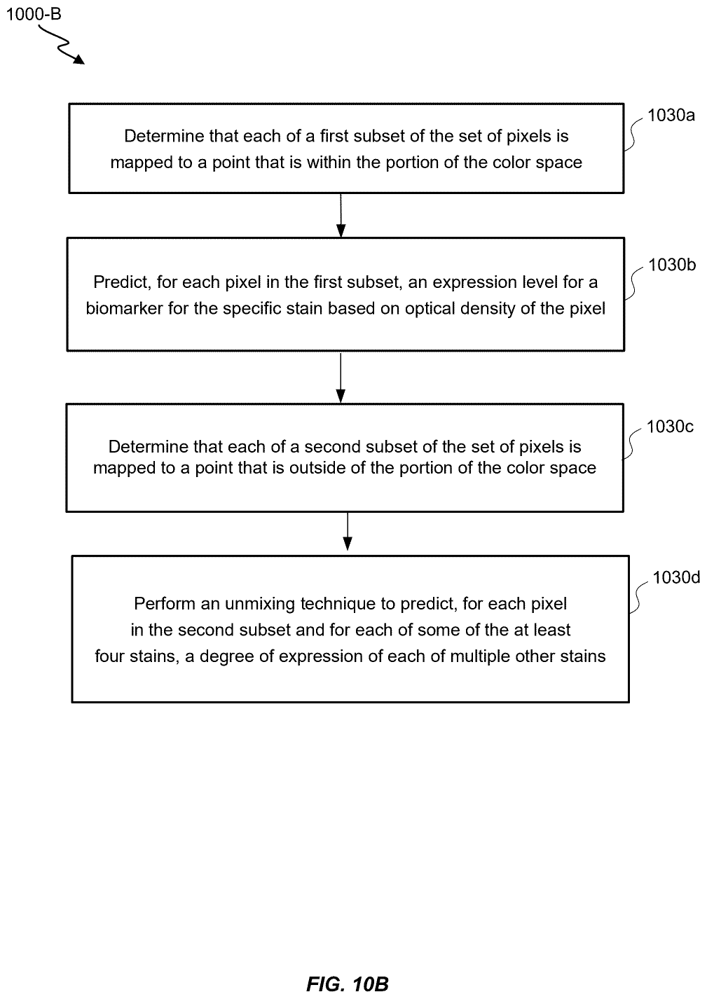

FIG. 10A illustrates an example flowchart of a process 1000-A for performing stain unmixing. The constraint technique can support more accurate, more precise, and/or more reliable generation of synthetic singleplex images from a multiplex image (e.g., that depicts a section of a sample stained with three or more dyes or with four or more dyes). For stain unmixing constraints may be added, which may have an effect of reducing the complexities of potential color analyses.

At block 1005, a color vector for each of at least four digital pathology stains is determined. The color vector(s) may be determined using a technique described in relation to block 405 of process 400 (or another technique disclosed herein). The color vectors may be adjusted in accordance with the technique stated above in FIG. 3A. In some instances, each pixel in a digital pathology image may be mapped to a position within a multi-dimensional color space. Among these four stains, a specific stain may be selected, at block 1010, such that it is attributable to a portion (e.g., a quadrant, a portion defined by greater than/less than some y-value and greater/less than some x-value, a wedge, cylinder etc.) of the color space, at block 1015. The specific stain may be one for which it is predicted that it will not be co-expressed with one, more or all other stains in the at least four stains. For example, the specific stain may include a stain configured to be absorbed by a cell nucleus (e.g., having a given biological characteristic), while the other stains may be configured to be absorbed by a cell membrane (e.g., having corresponding other biological characteristics). As another example, the specific stain may include a stain configured to be absorbed by a cell membrane (e.g., having a given biological characteristic), while the other stains may be configured to be absorbed by a cell nucleus (e.g., having corresponding other biological characteristics).

At block 1020, a real multiplex image that depicts a sample (e.g., tissue slice) that is stained with at least three digital pathology stains is accessed. Each pixel of the real multiplex image may be mapped to a point in the multi-dimensional space, at block 1025. At block 1030, for each pixel, a pixel-specific vector may be generated that predicts a degree of expression for each of at least four stains in the part of the biopsy section that is depicted at the pixel. Finally, one or more synthetic singleplex images may be generated using the pixel-specific color vectors, at block 1035.

FIG. 10B further illustrates an example flowchart of a component 1030 of FIG. 10A. At block 1030a, it is determined that each of a first subset of the set of pixels is mapped to a point that is within the specific portion of the color space. At block 1030b, for each pixel associated with the specific portion, an expression level for a biomarker associated with the specific stain that is associated with the portion is predicted based on an optical density of the pixel. For example, the portion of the color space may be a quadrant or wedge associated with a green channel, and a predicted expression of a biomarker associated with a green stain that is assigned to each pixel in the quadrant or wedge may be defined to be the optical density of the pixel. In some instances, a predicted expression level of the biomarker for each of the other at least four stains may be set to zero or another constant.

At block 1030c, a second subset of the set of pixels is defined, where each pixel in the second subset is mapped to a position outside the portion of the color space. At block 1030d, for pixels in the second subset, an unmixing technique (such as NMF) is performed to predict expression levels for each biomarker associated with the other stains in the at least four stains (excluding the stain associated with the portion). In some instances, an expression for the biomarker associated with the stain associated with the portion of the color space may be defined to be zero.

In multiplex immunohistochemistry (mIHC), a digital pathology image may be termed e.g., singleplex, duplex, triplex and the like depending on the number of different markers or stains used for staining. For example, singleplex staining may use a single marker or stain to the tissue section for visualization of a specific target or protein along with a counterstain. Similarly, in duplex and triplex staining two and three different markers respectively along with a counterstain may be applied for simultaneously detecting the respective number of different antigens (target proteins) within the single tissue sample. This technique can be used to study multiple biomarkers or antigens in the same tissue section providing comprehensive information about cellular interactions, heterogeneity, locations, functions, and visualization of these antigens. Such multiplex straining involves multiple primary antibodies, each recognizing a specific target, and then applying corresponding secondary antibodies labeled with distinct chromogens or fluorophores for visualization. In addition, multiplex staining e.g., triplex staining saves time compared to three simple staining and preserves valuable samples using less material and detection can be done on the same tissue section.

### Example Implementation:

An example implementation of the disclosed technique is provided for stain unmixing of the multiplex digital pathology images 110a-n or singleplex images 108a-m. In the following example, the stained slides were scanned at 20× magnification on a VENTANA DP200 scanner and were annotated with ten fields of view (FOV) per slide utilizing HALO image-analysis software. All FOVs underwent quality control (QC) by an independent team member to maintain consistency for placement of FOVs throughout the slides.

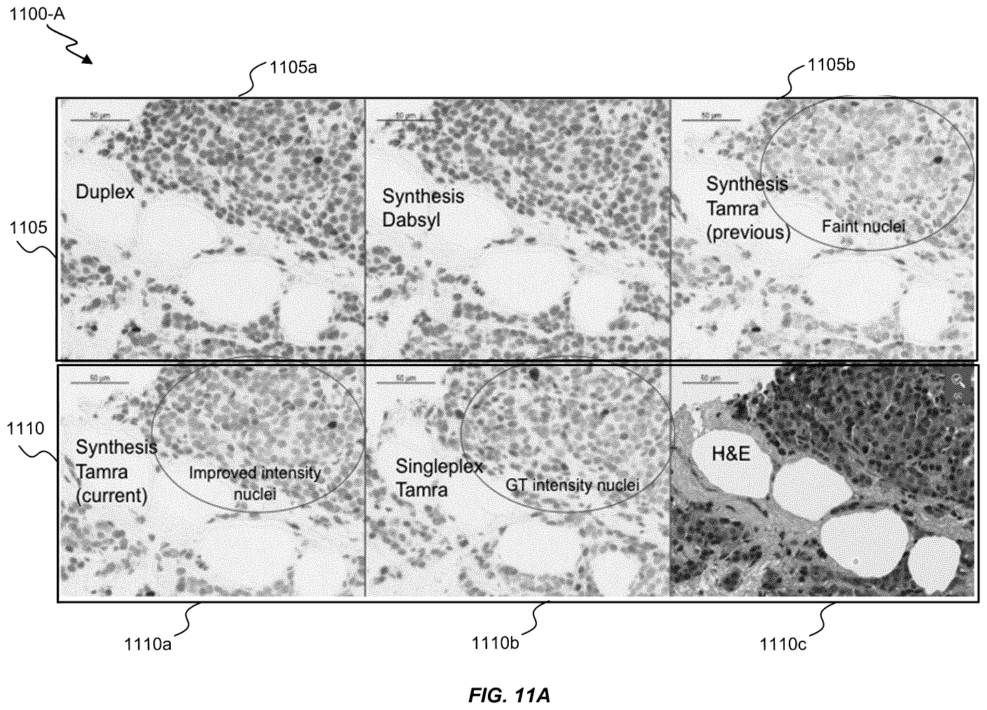

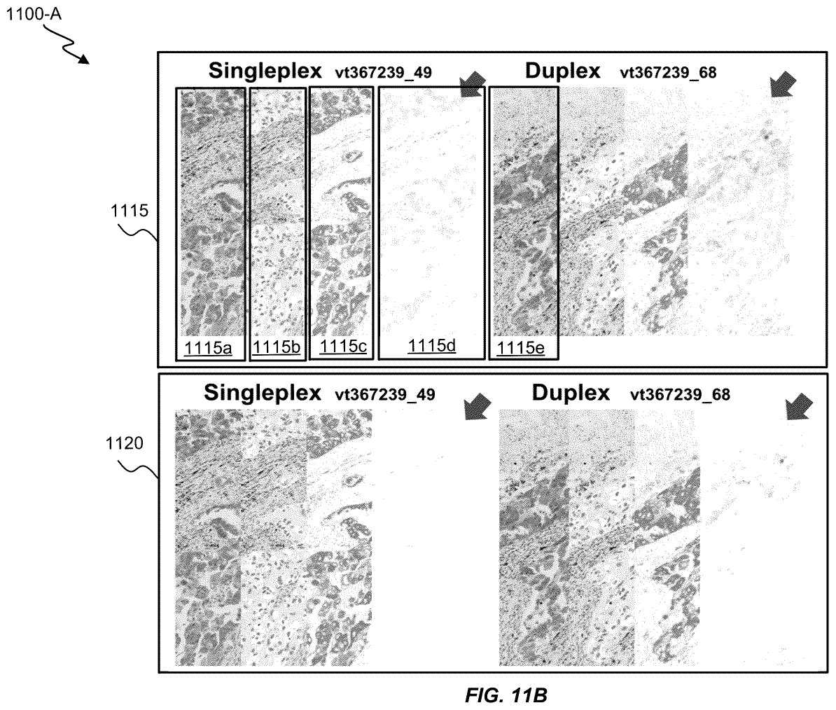

As stated before, the color vectors (initial W matrix) 315 obtained from non-negative matrix factorization (NMF) 310 may fail to perform well for stain unmixing. FIG. 11A depicts a comparison of stain unmixing 335 of a duplex image 1105a using initial color matrix 315 and the adjusted color matrix in accordance with an example implementation. The first row 1105 of FIG. 11A represents the unmixing performance using the conventional NMF 310 method. From synthetic TAMRA 1105b, white space or noise may be observed (e.g., the issues of faint/blurry nuclei (hematoxylin) seen in the synthetic TAMRA 1105b). The second row 1110 of FIG. 11A represents the unmixing performance of the duplex image 1105a with adjusted color matrix 325.

Higher clarity depictions of nuclei can be observed in the other synthetic TAMRA 1110a, which is obtained by shifting the Dabsyl vector to the left or away from the hematoxylin vector in the cx-cy space using the disclosed technique. This color vector modification strengthens the nucleus hematoxylin intensity and provides better nuclei signal (e.g., visibility of nucleoli, chromatins, etc.). The improved nucleus signal of the synthetic images is quite comparable to the signal quality in the ground-truth image 1110b and the H&E image 1110c. It may be understood that the ground-truth singleplex/multiplex images are from the serial tissue sections representing corresponding adjacent singleplex/multiplex images. For these ground-truth images, the tissue morphology fail to not match due to fact that the images are from adjacent slides, not the same slides. Thus, there remains tissue morphology differences.

FIG. 11B depicts a comparison of stain unmixing of another duplex image 1115e and a singleplex image 1115a using the initial color matrix and the adjusted color matrix. A color vector was investigated that detected TAMRA stain e.g., 1115d (images pointed by red arrows) while unmixing a singleplex Dabsyl 1115a and a duplex image 1115e with very weak TAMRA, as shown in the illustrative example of first row of FIG. 11B, respectively. The original color vector of TAMRA was adjusted until a color vector was obtained that unmixes the singleplex Dabsyl image 1115a with low to no TAMRA signal, that is, showing a very low TAMRA background. “Very low” means an intensity that approaches that of tissue with no cells present. The same color vector may be used to accurately detect TAMRA signal in images of samples where such signals are present, as illustrated in the second row 1120 of FIG. 11B. In these examples, the singleplex Dabsyl image 1115a comprise of blue (counterstain such as hematoxylin 1115b) and yellow channels 1115c, and it is expected to have a very small signal of TARMA (1115d). Starting from the initial color vectors, a calibration or fine-tuning of the color vectors is performed via an interactive graphic user interface (GUI) 112 as a semi-automatic method to adjust the color vector that can unmix the multiplex images in good quality. The second row 1120 of FIG. 11B shows the improved background noise in the TAMRA channel using the adjusted color vectors.

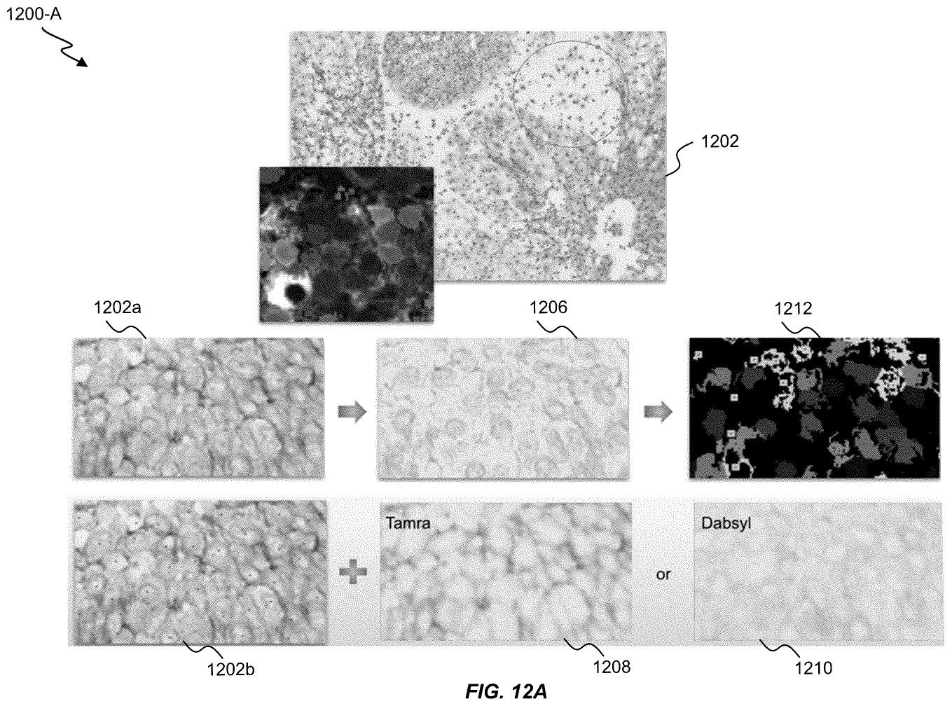

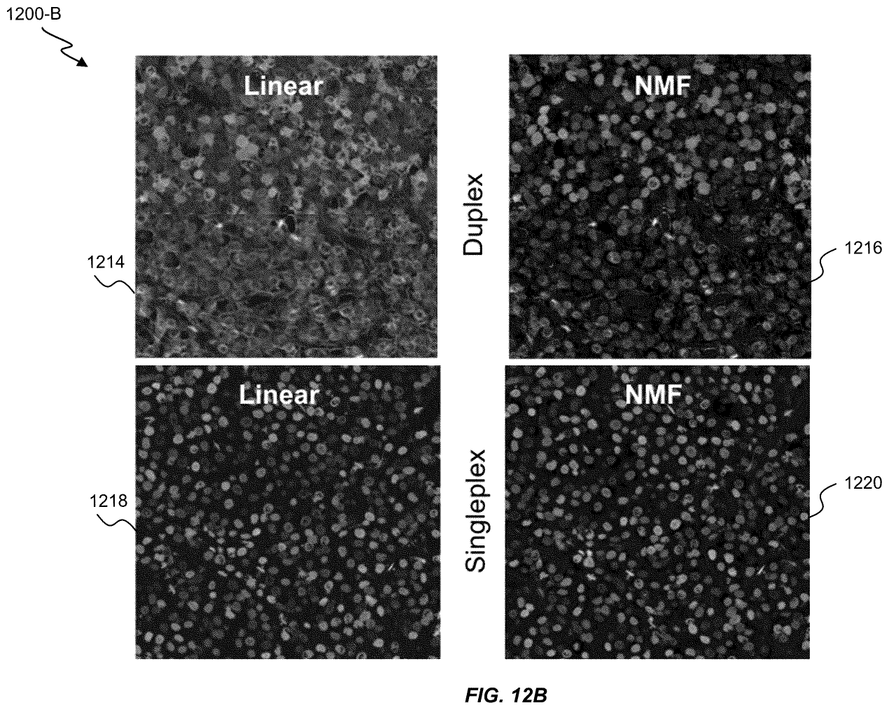

FIG. 12A illustrates an example of a duplex image 1202 overlaid with candidate seeds at each nucleus (marked by red dots) detected by automatic nucleus segmentation. In this example, automatic nucleus segmentation was performed based on an iterative modified radial symmetry method, Parvin et al., 2007 (see References). The algorithm was performed on hematoxylin image 1206 channels after unmixing the duplex image 1202. The duplex image 1202a provides a magnified view of a segment from 1202, while the duplex image 1202b displays 1202a with marked candidate seeds at each nucleus represented by red dots. The candidate seeds may serve as initial markers or reference points for nucleus segmentation. These candidate seeds and seed labels from the duplex image 1202 were detected and segmented (e.g., 1212 provided segmented image) using the unmixed hematoxylin 1206 as illustrated in FIG. 12A. Then, the Dabsyl 1210 and TAMRA 1208 intensities were attached to each candidate seed. A simple filtering was applied to remove some stroma cells or the cells that have very low Dabsyl 1210 and TAMRA 1208 intensities. The Dabsyl 1210 and TAMRA 1208 intensities were measured for each FOV.

FIG. 12B depicts a comparison of nucleus segmentation results of a hematoxylin image that is obtained by unmixing a duplex image using linear deconvolution (e.g., 1214) and NMF (e.g., 1216) techniques. It can be observed from the images that the hematoxylin image channel unmixed using the linear deconvolution method (e.g., 1214) are smearing and the cell regions are not defined well. In contrast, NMF unmixed the nucleus regions more accurately, yielding improved nucleus definition separated from the background (as shown in 1216).

The singleplex slide was also investigated using linear deconvolution and NMF (e.g., 1218 and 1220, respectively), and it was determined that the nucleus segmentation results obtained from both unmixing methods show comparable performance, as illustrated in second row of FIG. 12B. The number of nuclei derived from the duplex and singleplex images using the linear deconvolution and NMF methods (using the fine-tuning), respectively, are listed in TABLE 1. It shows that the number of nuclei derived from the duplex image using the linear deconvolution is much greater than the NMF method, whereas it does not show much difference in the singleplex images using both methods. The first duplex image was produced using a linear unmixing approach to generate a synthetic singleplex image. As shown in TABLE 1, 784 nuclei were detected in the synthetic singleplex image. Meanwhile, a real adjacent singleplex image depicted 563 nuclei, indicating a substantial inconsistency. Meanwhile, a second duplex image was produced using an NMF approach (that included the unmixing) to generate a synthetic singleplex image. As shown in TABLE 1, 624 nuclei were detected in the synthetic singleplex image. Meanwhile, a real adjacent singleplex image depicted 533 nuclei. Thus, it is estimated that the NMF results are more accurate than the linear unmixing approach.

TABLE 1
The number of nuclei derived from the duplex and singleplex images
using the linear deconvolution and NMF methods, respectively.

| Hematoxylin Seeds | Linear | NMF |
|---|---|---|
| Duplex | 784 | 624 |
| Singleplex | 563 | 533 |

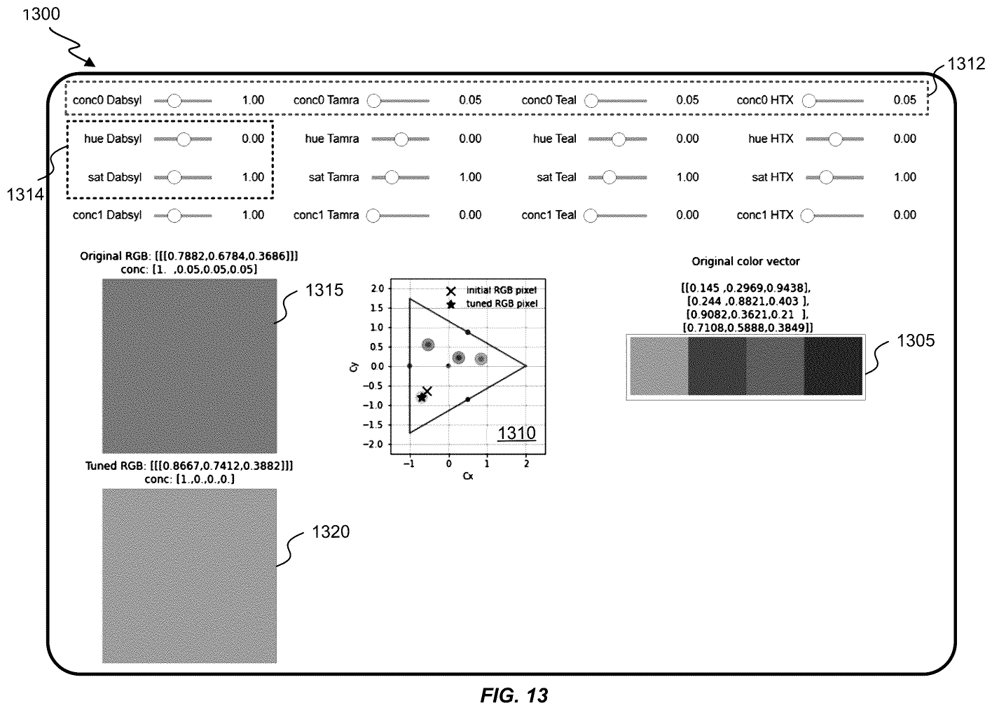

FIG. 13 illustrates an example graphical user interface (GUI) for generation of synthetic pixels. As stated before, interfaces may be configured to blend two or more stain colors interactively with different ratios and displayed in cx-cy plots. Additionally, a given color vector associated with a specific chromogen can be adjusted using the interface. For example, in the example interface 1300, a set of four chromogens (1305) along with the associated RGB values, e.g., Dabsyl [0.7108, 0.5888, 0.3849], TAMRA [0.9082, 0.3621, 0.21], Teal [0.244, 0.8821, 0.403] and hematoxylin [0.145, 0.2969, 0.9438] are shown. The corresponding color vectors are drawn as pixels in cx-cy plot 1310, where a marker (‘X’) represents an initial color vector for Dabsyl that may be adjusted by tuning various adjustment options from the interface 1300. For example, the concentration ratios (amount) for each of the chromogens 1305 may be selected via interface 1312. In addition to the amount of chromogen, the interface 1300 can also enable hue saturation adjustments 1314 for Dabsyl. By utilizing adjustment options 1312 and 1314 for Dabsyl, the adjusted Dabsyl 1315 can be observed with updated color vector of [0.7882, 0.6784, 0.3686] with concentration ratios from each chromogen of [1, 0.05, 0.05, 0.05, 0.05, 0.05], respectively. Further tuning of concentration ratios to [1, 0, 0, 0] by selecting options from 1312 may result in a tuned Dabsyl 1320 with updated RGB of [0.8667, 0.7412, 0.3882].

While adjusting the amount of stain/chromogen, the adjusted amount is multiplied by the corresponding color vectors in OD space, which is then converted back to RGB space for display. In the interface 1300, the tuned pixel for Dabsyl is shown in cx-cy plot represented by a (‘*’). The locations of the two pixels, e.g., Dabsyl initial (‘X’) and Dabsyl tuned (‘*’) in the cx-cy plot show how close the two pixels are in hue and saturation. Scaling up the amount of stain while keeping the relative ratios of the chromogens (e.g., composition remains same) does not change their locations in cx-cy plot but changes the appearance of the synthetic pixel, which is consistent with the design of cx-cy space that counts only hue and saturation while keeping density the same.

Such a user interface may enable (1) visual inspection of the range of colors generated by a particular combination of chromogens from biomarker assays for both pathologist users and algorithm developers; (2) provision of ground-truth for stain unmixing as the components of each chromogen that generates the synthetic color stains are known, therefore, color unmixing for a group of synthetic pixels can be performed and the results can be compared with the known settings used to generated these synthetic pixels; (3) study the potential unmixing errors (e.g. missing stain signals in some of the unmixed images) when applying various regularizations of NMF-based unmixing, such as wedge constraints; (4) help with selection and comparison of chromogens by assessing which chromogens are more feasible for unmixing.

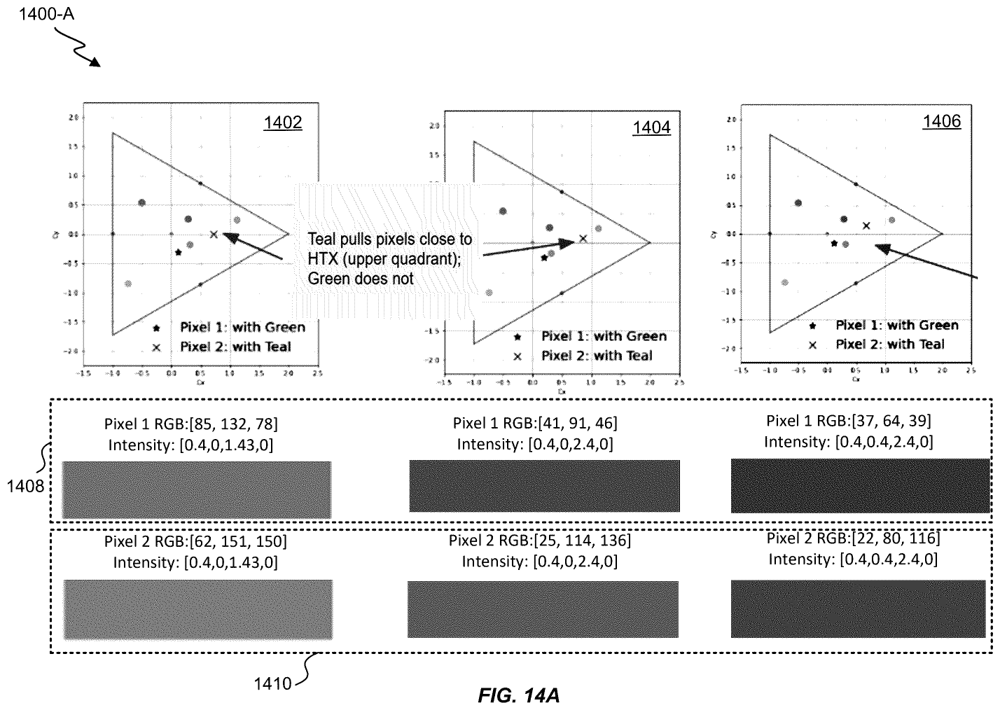

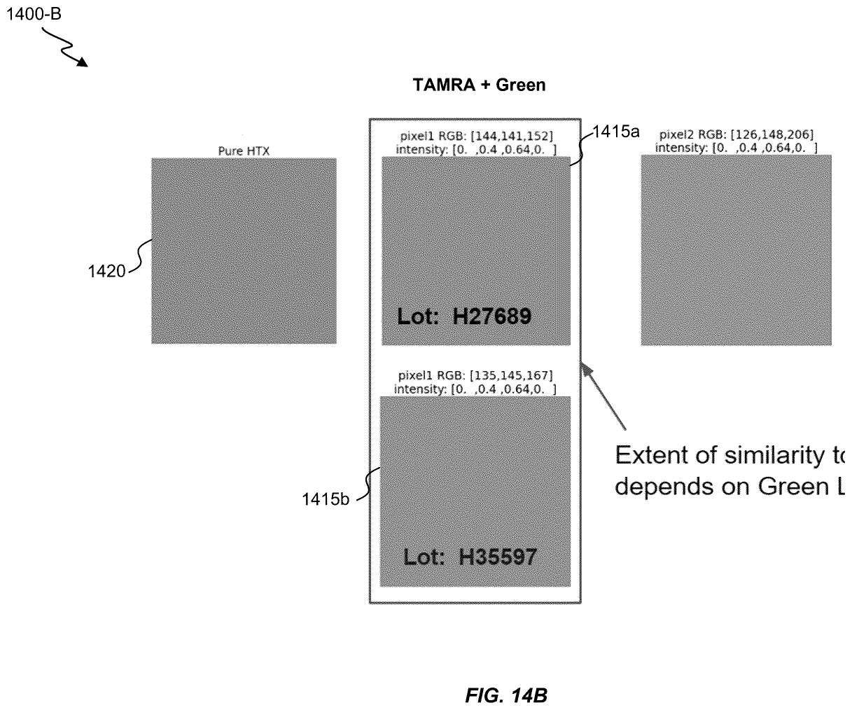

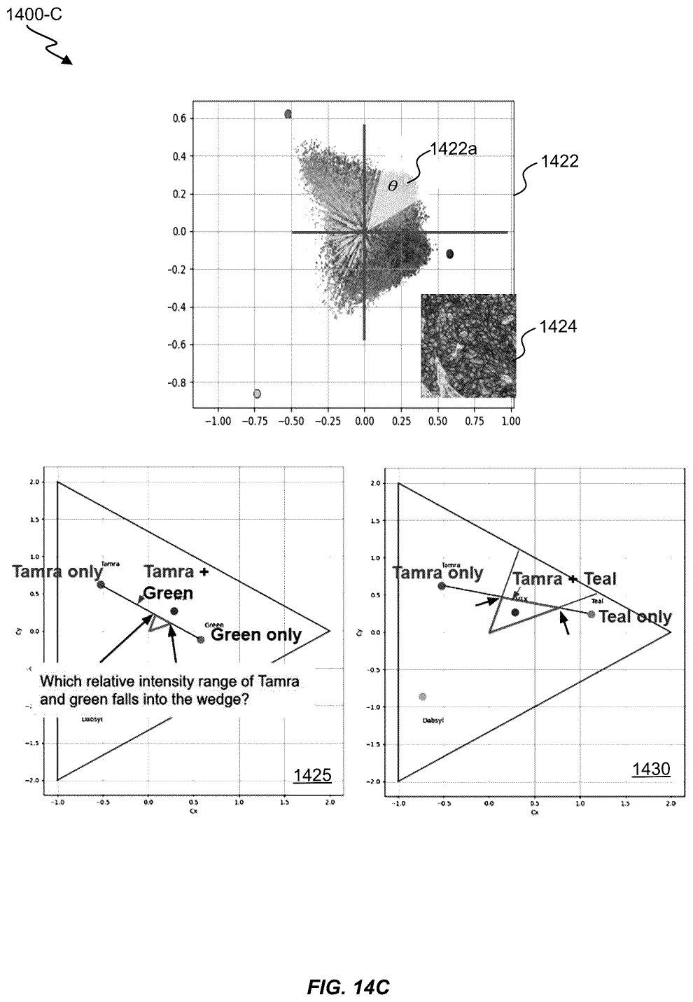

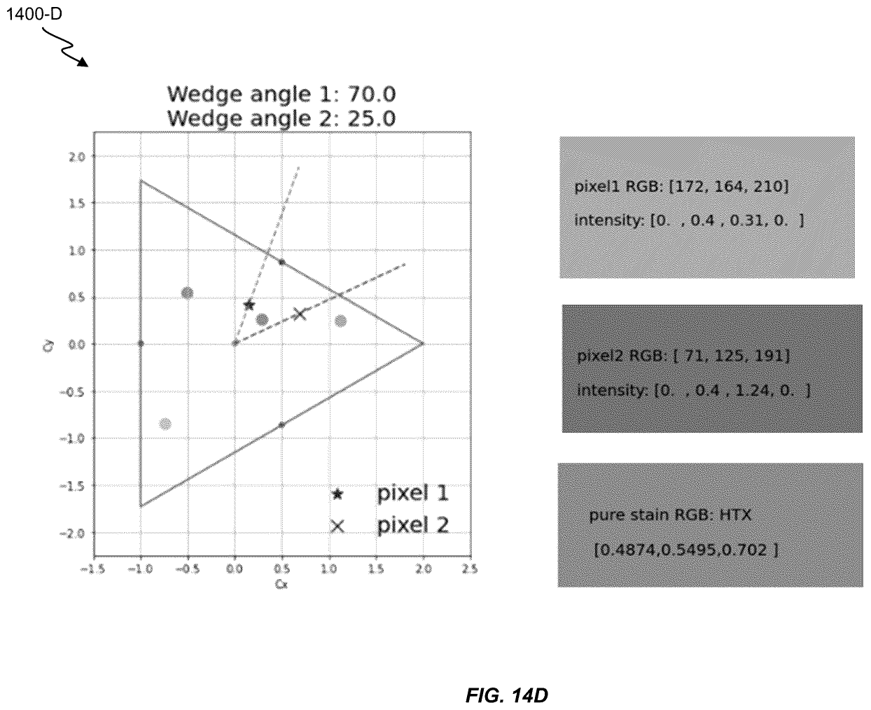

FIG. 14A illustrates an example GUI that uses synthetic pixels for assessing range of colors from blending of multiple chromogens. In a multiplex image, when multiple biomarkers are stained in the same or proximity of structures in a tissue (for example, a part of tissue that expresses multiple proteins detected by the assays), different chromogen colors may be blended. Such color blending may generate a range of colors depending on the nature of the chromogens as well as the relative amount of each chromogen deposited in the tissue structure. FIG. 14A includes cx-cy plots e.g., 1402 representing pixels associated with the constituting chromogens of a triplex image. In this plot 1402, an example color is generated by blending Green and QM-Dabsyl (Green row 1408 of synthetic pixels) represented as ‘*’ marker (pixel 1) in the cx-cy plot 1402. There is another example color generated by blending Teal and QM-Dabsyl (Teal row 1410 of synthetic pixels) represented as ‘x’ marker (pixel 2) in the cx-cy plot 1402. By adjusting these color vectors (associated with the synthetic pixel 1 and pixel 2) via various adjustment options in the interface, different ranges of Green and Teal can be achieved as illustrated in cx-cy plots 1404 and 1406 along with their generated color vectors in the rows 1408 and 1410, respectively.

Additionally, synthetic pixel generation interfaces can facilitate the selection and comparison of chromogens by assessing which chromogens are more feasible for unmixing as discussed in the process 700 of FIG. 7. Specifically, one can inspect color blending of a prefixed set of chromogens with one chromogen versus another under examination, and then determine quantitatively (by calculating how close in cx-cy space are the blended colors) and qualitatively (by visual inspection) which chromogen generates the color ranges that support accurate color unmixing. For example, a candidate chromogen can be an inferior choice if, when it blends with other chromogens, the blended colors are similar to another chromogen.

FIG. 14A further illustrates determining a recommended color as a third chromogen for a triplex assay. In the example of selecting between Teal and Green as a third chromogen for triplex assay (except for yellow-colored QM-Dabsyl and purple-colored TAMRA), it can be observed that the blending of either Teal (cyan-colored) or Green with QM-Dabsyl (purple-colored) can generate pixels with diverse appearance corresponding to a wide range of hue and saturation, but blending with Teal generates stain colors similar to hematoxylin as shown in row 1410 in FIG. 14A. Such color similarity with hematoxylin pixels may increase the difficulty of stain unmixing, since unmixing errors can occur when the blended pixel values are closer to hematoxylin that the algorithm mistakenly unmixes such pixels into Teal and QM-Dabsyl instead of hematoxylin. The results illustrated in the example implementation of FIG. 14A suggest supporting Green instead of Teal as the third chromogen.

FIG. 14B illustrates a comparison of one or more blended colors synthetized from a stain from different reagent sources in accordance with an example implementation. In this example, same type of chromogen (“Green”) from different reagent sources has been examined. The interface illustrates the associated colors of synthetic pixels generated from the user interface as discussed before and in FIG. 13. FIG. 14B includes color representation of pure hematoxylin 1420, a blend of TAMRA with Green from source 1 (Lot:H27689) and source 2 (Lot:H35597) in the blocks 1415a and 1415b, respectively. A chromogen from different reagent sources can result in stains of slightly different colors and the disclosed approach can help select the most reliable and favorable reagent source.

FIG. 14C illustrates an example of blending two or more chromogens generating a range of colors in accordance with an example implementation. The potential unmixing error may include e.g. missing stain signals in an unmixed singleplex image when applying various regularizations of NMF-based unmixing. With the constraint toolbox 960 for NMF, a triplex image can be unmixed based on the localization of biomarkers. FIG. 14C illustrates an example triplex 1424 of MET-PDL1-EGFR along with the associated cx-cy plot 1422. Using the wedge constraint of the NMF method, hematoxylin signals 1422a can be separated from the other positive biomarker stains in the first quadrant of the cx-cy space 1422. The remainder of the signals can be unmixed into Dabsyl, TAMRA and Green using 3-color unmixing in all the other quadrants. The applied wedge constraints on hematoxylin and assigned pixels within the wedge can be seen in cx-cy plot 1425 represented by red colored triangle in FIG. 14C. With the synthetic pixel generation user interface, the ranges of colors assigned to hematoxylin within the wedge can be assessed. These ranges of colors may be the results of blending TAMRA, Green and QM-Dabsyl.

Specifically, in cx-cy plot 1430 of FIG. 14C, blending of TAMRA and Teal may generate a range of colors, which in the cx-cy plot 1430 may lie on the line joining TAMRA and Green color vectors (dark red lines in the plot 1430). A small amount of QM-Dabsyl can pull the color towards the inside of the wedge. Such blended colors may be assigned to hematoxylin and thus generate unmixing errors. The extent of errors may depend on the relative amount of each chromogen, corresponding to expression levels of each biomarker that may be detected by the biomarker assay.

FIG. 14D illustrates assessing a range of colors assigned to hematoxylin with wedge constraint. In FIG. 14D, using the interface, one or more example colors that may be incorrectly assigned to hematoxylin, can be visualized. Quantitatively, how big the range of colors assigned to hematoxylin can be calculated are using, for example, L2 norm of their cx-cy values between two colors that intersecting the wedge lines and the line connecting TAMRA and Green color vectors (gray arrows in FIG. 14C).

Some embodiments of the present disclosure include a system including one or more data processors. In some embodiments, the system includes a non-transitory computer-readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The present description provides preferred exemplary embodiments only, and is not intended to limit the scope, applicability or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

What is claimed is:

1. A computer-program product tangibly embodied in a non-transitory machine-readable storage medium, including instructions configured to cause one or more data processors to perform actions including:
determining, for each stain of at least three digital pathology stains, a color vector that represents the stain;
availing an interface to a user device, wherein the interface includes:
a representation of each of the determined color vectors, wherein the representation of each of the determined color vectors includes a representation of a position within an optical density space;
a real multiplex digital pathology image that depicts a biopsy section stained with two or more of the at least three digital pathology stains;
at least one synthetic singleplex image, wherein each of the at least one synthetic singleplex image is generated by filtering the real multiplex digital pathology image using a single one of the determined color vectors; and
one or more color-vector adjustment tools, wherein each of the one or more color-vector adjustment tools are configured to receive user input corresponding to an adjustment of a color vector representing a corresponding stain of the at least three digital pathology stains;
detecting an input received via an interaction with the interface that corresponds to a particular adjustment of the color vector representing a particular stain of the at least three digital pathology stains; and
in response to detecting the input, automatically updating the interface, wherein the updated interface further includes the at least one synthetic singleplex image.

2. The computer-program product of claim 1, wherein determining the color vector comprises processing one or more single-stain images that depict a same or other biopsy section that had been stained with only one of the at least three digital pathology stains.

3. The computer-program product of claim 1, wherein the actions further comprise:
receiving a new multiplex image stained with at least one of the at least three digital pathology stains;
generating a new synthetic singleplex image based on the new multiplex image and the adjusted color vector; and
outputting the new synthetic singleplex image.

4. A computer-program product tangibly embodied in a non-transitory machine-readable storage medium, including instructions configured to cause one or more data processors to perform actions including:
determining, for each stain of at least three digital pathology stains, a color vector that represents the stain;
accessing a real multiplex digital pathology image that depicts a biopsy section stained with at least one first stain of the at least three stains, wherein the depicted biopsy section is not stained with at least one second stain of the at least three stains;
generating a filtered output by filtering the real multiplex digital pathology image using the color vector that represents a second stain of the at least one second stain;
generating a metric that characterizes a signal characteristic in the filtered output;
using the metric and a space-traversal technique to identify an adjustment of the color vector that represents the second stain;
receiving a new multiplex image stained with at least one of the at least three digital pathology stains;
generating a new synthetic singleplex image based on the new multiplex image and the adjusted color vector that represents the second stain; and
outputting the new synthetic singleplex image.

5. The computer-program product of claim 4, wherein, for each stain of the at least three digital pathology stains, the color vector is a vector in an optical density space.

6. The computer-program product of claim 4, wherein the space-traversal technique includes a gradient descent technique.

7. The computer-program product of claim 4, wherein the space-traversal technique includes a Monte Carlo technique.

8. A computer-program product tangibly embodied in a non-transitory machine-readable storage medium, including instructions configured to cause one or more data processors to perform actions including:
determining, for each stain of at least two digital pathology stains, a color vector that represents the stain;
accessing a real multiplex digital pathology image that depicts a biopsy section stained with the at least two digital pathology stains;
identifying a recommended color vector that represents a potential additional stain by:
identifying an initial color vector;
generating a filtered output by filtering the real multiplex digital pathology image using the initial color vector;
generating a metric that characterizes a signal characteristic in the filtered output; and
using the metric and a space-traversal technique to identify the recommended color vector; and
outputting the recommended color vector.

9. The computer-program product of claim 8, wherein the space-traversal technique is performed to include, as one or more objectives in a traversal, to minimize signal in the filtered output.

10. The computer-program product of claim 8, wherein, for each stain of the at least two digital pathology stains, the color vector is a vector in an optical density space.

11. The computer-program product of claim 8, wherein the filtered output is generated by using a machine-learning model.

12. The computer-program product of claim 8, wherein the determination of color vectors is performed using non-negative matrix factorization.

13. A computer-program product tangibly embodied in a non-transitory machine-readable storage medium, including instructions configured to cause one or more data processors to perform actions including:
determining, for each stain of at least three digital pathology stains, a color vector that represents the stain;
accessing a real multiplex digital pathology image that depicts a biopsy section stained with at least one first stain of the at least three digital pathology stains, wherein the depicted biopsy section is not stained with at least one second stain of the at least three stains;
generating a filtered output by filtering the real multiplex digital pathology using the color vector that represents a second stain of the at least one second stain;
generating a performance-prediction score that represented a predicted extent to which the at least three digital pathology stains are sufficiently separable in practice to reliably support generation of synthetic singleplex images; and
outputting the performance-prediction score.

14. The computer-program product of claim 13, wherein the performance-prediction score is generated using the filtered output.

15. The computer-program product of claim 13, wherein, for each stain of at least two digital pathology stains, the color vector is a vector in an optical density space.

16. The computer-program product of claim 13, wherein the color vector is adjusted via a graphical user interface (GUI) based on the performance-prediction score.

17. A computer-program product tangibly embodied in a non-transitory machine-readable storage medium, including instructions configured to cause one or more data processors to perform actions including:
determining, for each stain of at least four digital pathology stains, a color vector that represents the stain; wherein the determined color vectors are within a multi-dimensional color space,
selecting a specific stain of the at least four digital pathology stains;
determining a portion of the color space that is predicted to be attributable to prominent signals that correspond to a the specific stain;
accessing a real multiplex digital pathology image that depicts a biopsy section stained with at least three digital pathology stains of the at least four digital pathology stains, wherein the real multiplex digital pathology image includes a set of pixels;
mapping each pixel of the set of pixels in the real multiplex digital pathology image to a point within the multi-dimensional color space;
generating, for each pixel of the set of pixels, a pixel-specific color vector that predicts, for each of the at least four digital pathology stains, a degree of expression of the stain in a part of the biopsy section that is depicted at the pixel, wherein generating the pixel-specific color vectors includes:
determining that each of a first subset of the set of pixels is mapped to a point that is within the portion of the color space;
determining, for each pixel of the first subset of pixels, an optical density, wherein the pixel-specific color vector for the pixel identifies a degree of expression for the specific stain that corresponds to the optical density;
determining that each of a second subset of the set of pixels is mapped to a point that is outside of the portion of the color space; and
performing an unmixing technique to predict, for each pixel in the second subset and for each of some of the at least four digital pathology stains, a degree of expression of the stain in the part of the biopsy section that is depicted at the pixel, wherein the some of the at least four digital pathology stains does not include the specific stain, and wherein the unmixing technique uses the color vector determined to represent each of the some of the at least four digital pathology stains; and
generating one or more synthetic singleplex images using the pixel-specific color vectors.

18. The computer-program product of claim 17, wherein the specific stain is selected based on information about what parts of cells each of the at least four digital pathology stains are configured to stain.

19. The computer-program product of claim 17, wherein the portion of the color space includes a wedge, a combination of primitives or a portion of a space defined based on an inequality with respect to an x-coordinate and an inequality with respect to a y-coordinate.

20. The computer-program product of claim 17, wherein performing the unmixing technique includes using nonnegative matrix factorization (NMF).

21. The computer-program product of claim 17, wherein the color vectors are determined based on one or more user inputs received using one or more color-vector adjustment tools available within an interface.
